(19) United States
(12) Patent Application Publication
(10) Pub. No.: US 2024/0381393 A1
(43) Pub. Date: Nov. 14, 2024

(54) SIDELINK POWER CONTROL WITH CARRIER AGGREGATION

(71) Applicant: Samsung Electronics Co., Ltd., Suwon-si (KR)

(72) Inventors: Carmela Cozzo, San Diego, CA (US); Emad Nader Farag, Flanders, NJ (US); Hongbo Si, Allen, TX (US)

(21) Appl. No.: 18/649,833

(22) Filed: Apr. 29, 2024

Related U.S. Application Data
(60) Provisional application No. 63/465,720, filed on May 11, 2023.

(51) Int. Cl. H04W 72/40

(52) U.S. Cl. CPC H04W 72/40

(57) ABSTRACT

Apparatuses and methods for sidelink power control with carrier aggregation. A method of user equipment (UE) in a wireless communication system includes receiving a set of configurations for sidelink operation on multiple carriers from a higher layer and information for a maximum power for transmission on the multiple carriers and identifying, based on a UE capability a maximum number of physical sidelink feedback channels (PSFCHs) for simultaneous transmissions. The method further includes determining, based on the set of configurations, a first number of PSFCHs, PSFCH transmission occasions for the first number of PSFCHs in corresponding first number of carriers from the multiple carriers, and a power for transmission of a PSFCH from the first number of PSFCHs and simultaneously transmitting, in the PSFCH transmission occasions, the first number of PSFCHs with the power in the first number of carriers.

### CROSS-REFERENCE TO RELATED AND CLAIM OF PRIORITY

The present application claims priority under 35 U.S.C. § 119 (e) to U.S. Provisional Patent Application No. 63/465,720 filed on May 11, 2023, which is hereby incorporated by reference in its entirety.

### TECHNICAL FIELD

The present disclosure relates generally to wireless communication systems and, more specifically, the present disclosure is related to apparatus and method for sidelink (SL) power control with carrier aggregation (CA).

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance. To meet the demand for wireless data traffic having increased since deployment of 4G communication systems, and to enable various vertical applications, 5G communication systems have been developed and are currently being deployed.

### SUMMARY

The present disclosure relates to SL power control with CA.

In one embodiment, a user equipment (UE) in a wireless communication system is provided. The UE includes a transceiver configured to receive a set of configurations for sidelink operation on multiple carriers from a higher layer and information for a maximum power for transmission on the multiple carriers. The UE further includes a processor operably coupled to the transceiver. The processor is configured to identify, based on a UE capability, a maximum number of physical sidelink feedback channels (PSFCHs) for simultaneous transmissions, and determine, based on the set of configurations a first number of PSFCHs, PSFCH transmission occasions for the first number of PSFCHs in corresponding first number of carriers from the multiple carriers, and a power for transmission of a PSFCH from the first number of PSFCHs. The first number of PSFCHs does not exceed the maximum number of PSFCHs. A total power for transmission of the first number of PSFCHs does not exceed the maximum power. The transceiver is further configured to simultaneously transmit, in the PSFCH transmission occasions, the first number of PSFCHs with the power in the first number of carriers.

In another embodiment, a method of UE in a wireless communication system is provided. The method includes receiving a set of configurations for sidelink operation on multiple carriers from a higher layer and information for a maximum power for transmission on the multiple carriers and identifying, based on a UE capability a maximum number of PSFCHs for simultaneous transmissions. The method further includes determining, based on the set of configurations a first number of PSFCHs, PSFCH transmission occasions for the first number of PSFCHs in corresponding first number of carriers from the multiple carriers, and a power for transmission of a PSFCH from the first number of PSFCHs and simultaneously transmitting, in the PSFCH transmission occasions, the first number of PSFCHs with the power in the first number of carriers.

The first number of PSFCHs does not exceed the maximum number of PSFCHs. A total power for transmission of the first number of PSFCHs does not exceed the maximum power.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIG. 4A and 4B illustrates an example of a wireless transmit and receive paths according to embodiments of the present disclosure;

FIG. 5 illustrates a flowchart of an example process for a layer-2 link establishment for unicast mode of vehicle to everything (V2X) communication over protocol layer convergence for 5G new radio (PC5) reference point according to embodiments of the present disclosure;

FIG. 6 illustrates a diagram of an example CA configuration according to embodiments of the present disclosure;

FIG. 7 illustrates a diagram of an example CA configuration according to embodiments of the present disclosure;

FIG. 8 illustrates a diagram of an example CA configuration for physical sidelink shared channel (PSSCH) and PSFCH transmission over different carriers according to embodiments of the present disclosure; and

FIG. 9 illustrates an example method performed by a UE in a wireless communication system according to embodiments of the present disclosure.

### DETAILED DESCRIPTION

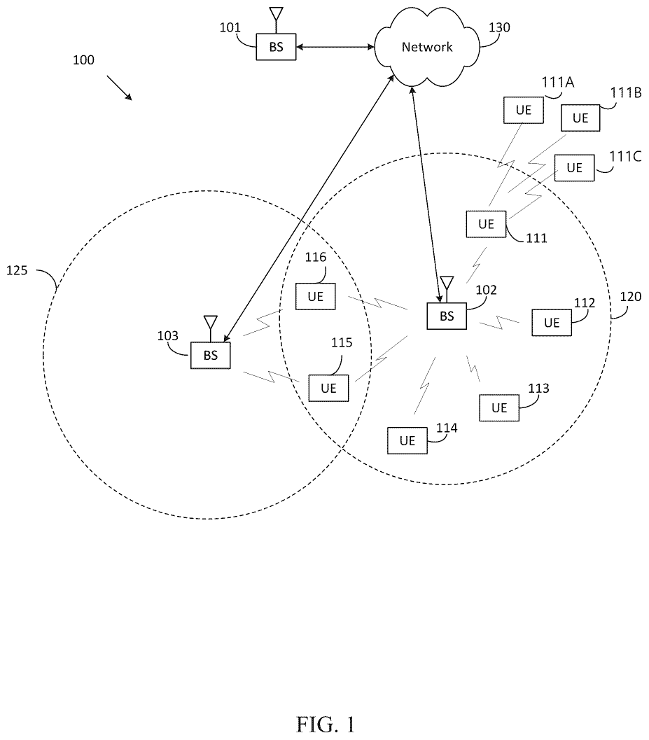

FIGS. 1-9, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band.

For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [1] 3GPP TS 38.211 v17.4.0, “NR; Physical channels and modulation;” [2] 3GPP TS 38.212 v17.4.0, “NR; Multiplexing and Channel coding;” [3] 3GPP TS 38.213 v17.4.0, “NR; Physical Layer Procedures for Control;” [4] 3GPP TS 38.214 v17.4.0, “NR; Physical Layer Procedures for Data;” [5] 3GPP TS 38.321 v17.3.0, “NR; Medium Access Control (MAC) protocol specification;” [6] 3GPP TS 38.331 v17.3.0, “NR; Radio Resource Control (RRC) Protocol Specification;” [7] 3GPP TS 36.213 v17.4.0, “Evolved Universal Terrestrial Radio Access (E-UTRA); Physical layer procedures;” and [8] RP-213678,“WID on NR sidelink evolution”, OPPO, LG Electronics, e-meeting December 2021.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands. FIGS. 1-3 below describe various embodiments implemented in wireless

communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing SL power control with CA. In certain embodiments, one or more of the BSs 101-103 include circuitry, programing, or a combination thereof for supporting SL power control with CA.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to common fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

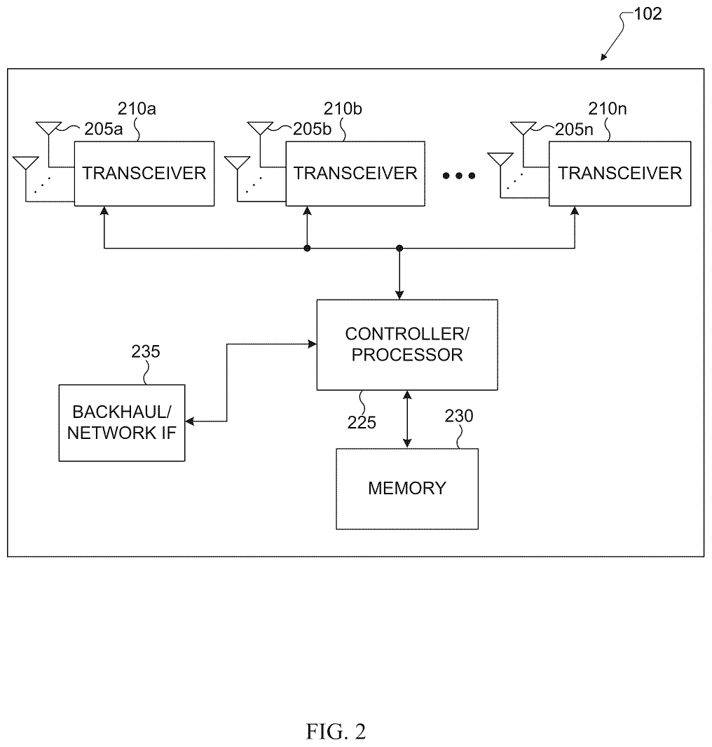

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting SL power control with CA. Any of a wide variety of other functions could be supported in the gNB 102 by the controller/processor 225.

The controller/processor 225 is also capable of executing programs and other processes resident in the memory 230, such as SL power control with CA. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

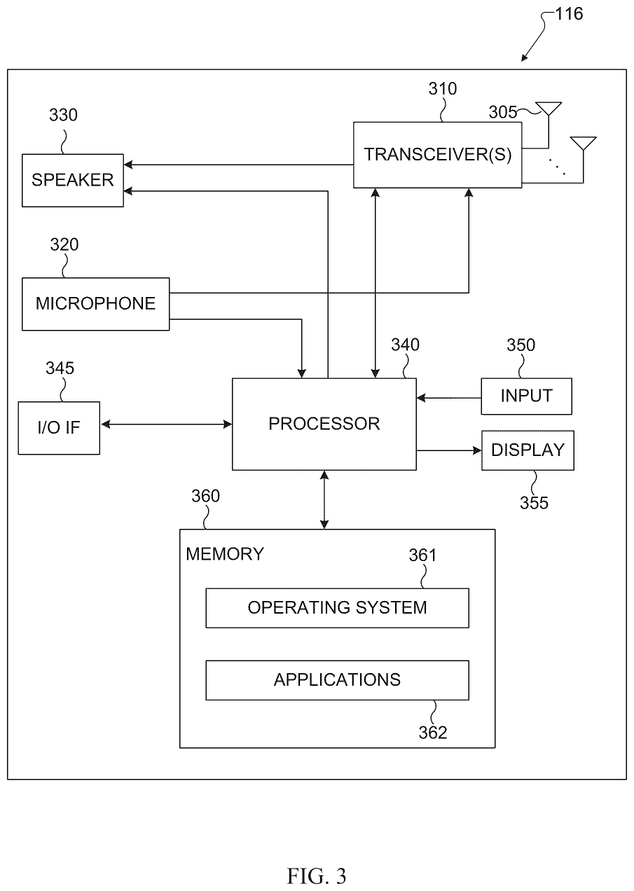

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL and/or SL channels and/or signals and the transmission of UL and/or SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for supporting or utilizing SL power control with CA as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

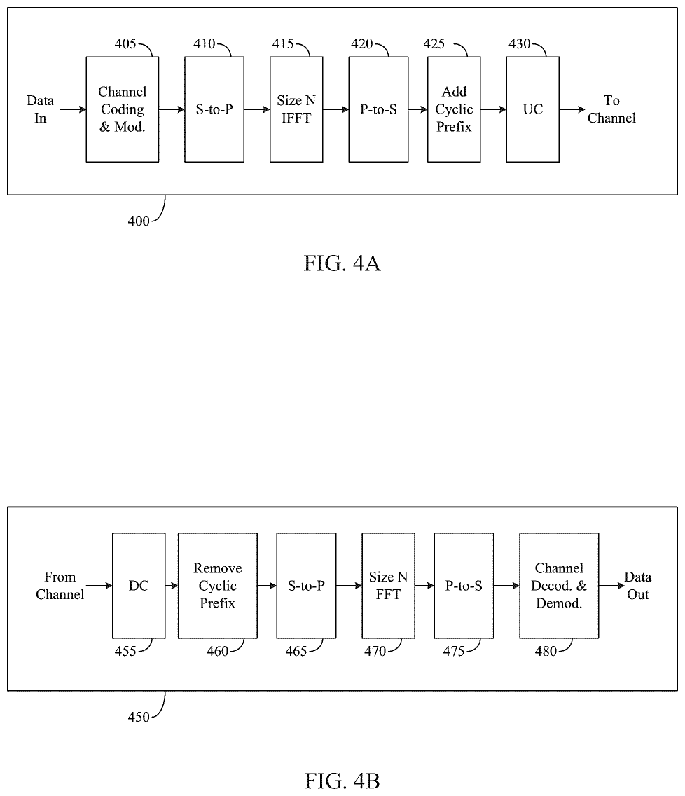

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. It may also be understood that the receive path 450 can be implemented in a first UE and that the transmit path 400 can be implemented in a second UE to support SL communications. In some embodiments, the receive path 450 is configured to support SL power control with CA as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

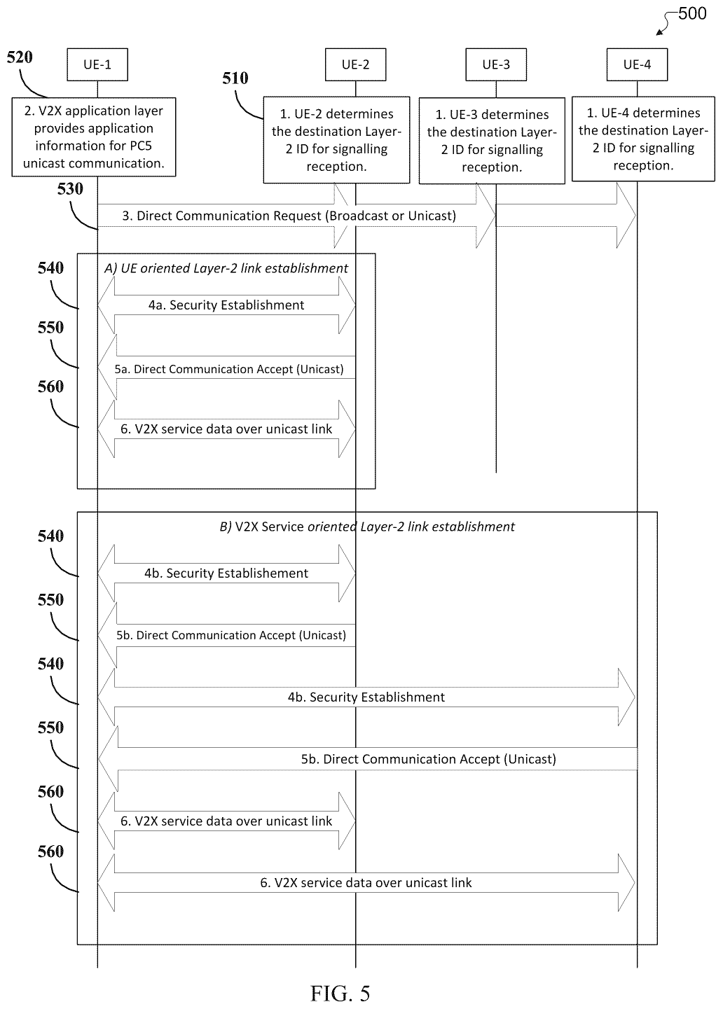

FIG. 5 illustrates a flowchart of an example process 500 for a layer-2 link establishment for unicast mode of V2X communication over PC5 reference point according to embodiments of the present disclosure. For example, process 500 can be performed by multiple of the UEs 111-116 of FIG. 1 to perform SL communications. This example is for illustration only and other embodiments can be used without departing from the scope of the present disclosure.

Process 500 begins in step 510, the UE(s) determine the destination Layer-2 ID for signaling reception of PC5 unicast link establishment. This is determined as specified in clause 5.6.1.4 of TS 23.387. The destination Layer-2 ID is configured with the UE(s) as specified in clause 5.1.2.1 of TS 23.387. In step 520, the V2X application layer in UE-1 provides application information for PC5 unicast communicating. In step 530, UE-1 sends a Direct Communication Request (DCR) to initiate the unicast layer-2 link establishment procedure and sends the DCR message via PC5 broadcast or unicast using the source Layer-2 ID and destination Layer-2 ID. In step 540, the target UE, or the UEs that are interested in using the announced V2X service type(s) over a PC5 unicast link with UE-1, responds which establishes the security with UE-1. In step 550, the target UE(s) that has successfully established security with UE-1 sends a direct communication accept message to UE-1. In step 560, V2X service data is transmitted over the established unicast link.

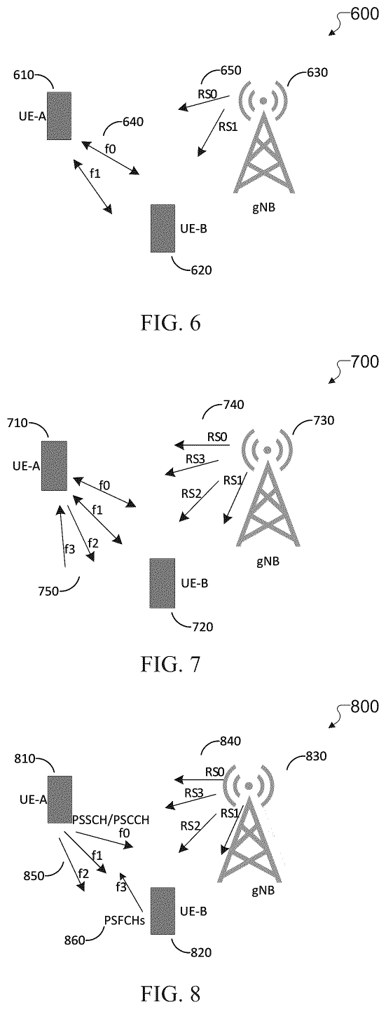

With reference to FIG. 5 (FIG. 6.3.3.1-1 of TS 23.387) the Layer-2 link establishment procedure for unicast mode of V2X communication over PC5 reference point is shown.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14symbols and an RB can have a BW of 720 kHz and include 12 SCs with SC spacing of 60 KHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1). In addition, a slot can have symbols for SL communications. A UE can be configured one or more bandwidth parts (BWPs) of a system BW for transmissions or receptions of signals or channels.

SL signals and channels are transmitted and received on sub-channels within a resource pool, where a resource pool is a set of time-frequency resources used for SL transmission and reception within a SL BWP. SL channels include physical SL shared channels (PSSCHs) conveying data information and second stage/part SL control information (SCI), physical SL control channels (PSCCHs) conveying first stage/part SCI for scheduling transmissions/receptions of PSSCHs, physical SL feedback channels (PSFCHs) conveying hybrid automatic repeat request acknowledgement (HARQ-ACK) information in response to correct (ACK value) or incorrect (negative acknowledgment (NACK) value) transport block receptions in respective PSSCHs, and physical SL Broadcast channel (PSBCH) conveying system information to assist in SL synchronization. SL signals include demodulation reference signals (DM-RS) that are multiplexed in PSSCH or PSCCH transmissions to assist with data or SCI demodulation, channel state information reference signals (CSI-RS) for channel measurements, phase tracking reference signals (PT-RS) for tracking a carrier phase, and SL primary synchronization signals (S-PSS) and SL secondary synchronization signals (S-SSS) for SL synchronization. SCI can include two parts/stages corresponding to two respective SCI formats where, for example, the first SCI format is multiplexed on a PSCCH, and the second SCI format is multiplexed along with SL data on a PSSCH that is transmitted in physical resources indicated by the first SCI format.

A SL channel can operate in different cast modes. In a unicast mode, a PSCCH/PSSCH conveys SL information from one UE to only one other UE. In a groupcast mode, a PSCCH/PSSCH conveys SL information from one UE to a group of UEs within a (pre-) configured set. In a broadcast mode, a PSCCH/PSSCH conveys SL information from one UE to surrounding UEs. In NR release 16, there are two resource allocation modes for a PSCCH/PSSCH transmission. In resource allocation mode 1, a gNB schedules a UE on the SL and conveys scheduling information to the UE transmitting on the SL through a downlink control information (DCI) format (e.g., DCI Format 3_0) transmitted from the gNB on the DL. In resource allocation mode 2, a UE schedules a SL transmission. SL transmissions can operate within network coverage where each UE is within the communication range of a gNB, outside network coverage where UEs have no communication with any gNB, or with partial network coverage, where only some UEs are within the communication range of a gNB.

In case of groupcast PSCCH/PSSCH transmission, a network can configure a UE one of two options for reporting of HARQ-ACK information by the UE:
HARQ-ACK reporting option (1): A UE can attempt to decode a transport block (TB) in a PSSCH reception if, for example, the UE detects a SCI format scheduling the TB reception through a corresponding PSSCH. If the UE fails to correctly decode the TB, the UE multiplexes a negative acknowledgement (NACK) in a PSFCH transmission. In this option, the UE does not transmit a PSFCH with a positive acknowledgment (ACK) when the UE correctly decodes the TB.
HARQ-ACK reporting option (2): A UE can attempt to decode a TB if, for example, the UE detects a SCI format that schedules a corresponding PSSCH. If the UE correctly decodes the TB, the UE multiplexes an ACK in a PSFCH transmission; otherwise, if the UE does not correctly decode the TB, the UE multiplexes a NACK in a PSFCH transmission.

In HARQ-ACK reporting option (1), when a UE that transmitted the PSSCH detects a NACK in a PSFCH reception, the UE can transmit another PSSCH with the TB (retransmission of the TB). In HARQ-ACK reporting option (2) when a UE that transmitted the PSSCH does not detect an ACK in a PSFCH reception, such as when the UE detects a NACK or does not detect a PSFCH reception, the UE can transmit another PSSCH with the TB.

A sidelink resource pool includes a set/pool of slots and a set/pool of RBs used for sidelink transmission and sidelink reception. A set of slots which belong to a sidelink resource pool can be denoted by {t′₀^{SL}, t′₁^{SL}, t′₂^{SL}, . . . , t′_{T′}_{_{MAX}}_{^{−1}}^{SL}} and can be configured, for example, at least using a bitmap. Where, T′_{MAX} is the number of SL slots in a resource pool within 1024 frames. Within each slot t′_{y}^{SL} of a sidelink resource pool, there are N_{subCH} contiguous sub-channels in the frequency domain for sidelink transmission, where N_{subCH} is provided by a higher-layer parameter. Subchannel m, where m is between 0 and N_{subCH}−1, is given by a set of n_{subCHsize} contiguous PRBs, given by N_{PRB}=n_{subCHstart}+m·n_{subCHsize}+j, where j=0, 1, . . . , n_{subCHsize}−1, n_{subCHstart} and n_{subCHsize} are provided by higher layer parameters.

For resource (re-) selection or re-evaluation in slot n, a UE can determine a set of

available single-slot resources for transmission within a resource selection window [n+T₁, n+T₂], such that a single-slot resource for transmission, R_{x,y} is defined as a set of L_{subCH} contiguous subchannels x+i, where i=0, 1, . . . , L_{subCH}−1 in slot t_{y}^{SL}. T₁ is determined by the UE such that, 0≤T₁≤T_{proc,1}^{SL}, where T_{proc,1}^{SL} is a PSSCH processing time, for example, as defined in TS 38.214[REF4] Table 8.1.4-2. T₂ is determined by the UE such that T₂ₘᵢₙ≤T₂≤Remaining Packet Delay Budget, as long as T₂ₘᵢₙ<Remaining Packet Delay Budget, else T₂ is equal to the Remaining Packet Delay Budget. T₂ₘᵢₙ is a configured by higher layers and depends on the priority of the SL transmission.

The slots of a SL resource pool are determined as follows:
1. Let set of slots that may belong to a resource be denoted by {tₒ^{SL}, t₁^{SL}, t₂^{SL}, . . . , t_{T}_{_{MAX}}₋₁^{SL}}, where 0≤tᵢ^{SL}<10240×2^{μ}, and 0≤i<Tₘₐₓ. μ is the sub-carrier spacing configuration. μ=0 for a 15 kHz sub-carrier spacing. μ=1 for a 30 kHz sub-carrier spacing. μ=2 for a 60 kHz sub-carrier spacing. μ=8 for a 120 kHz sub-carrier spacing. The slot index is relative to slot #0 of system frame number (SFN) #0 of the serving cell, or downlink frame number (DFN) #0. The set of slots includes slots except:
   a. N_{S-SSB} slots that are configured for SL synchronization signal/physical broadcast channel (SS/PBCH) Block (S-SSB).
   b. N_{nonSL} slots where at least one SL symbol is not semi-statically configured as UL symbol by higher layer parameter tdd-UL-DL-ConfigurationCommon or sl-TDD-Configuration. In a SL slot, OFDM symbols Y-th, (Y+1)-th, . . . , (Y+X−1)-th are SL symbols, where Y is determined by the higher layer parameter sl-StartSymbol and X is determined by higher layer parameter sl-LengthSymbols.
   c. N_{reserved} reserved slots. Reserved slots are determined such that the slots in the set {tₒ^{SL}, t₁^{SL}, t₂^{SL}, . . . , t_{T}_{_{MAX−1}}^{SL}} is a multiple of the bitmap length (L_{bitmap}), where the bitmap (b₀, b₁, . . . , b_{L}_{_{bitmap−1}}) is configured by higher layers. The reserved slots are determined as follows:
      i. Let {l₀, l₁, . . . , l₂_{^{μ}}_{×10240-N}_{_{S-SSB}}_{-N}_{_{nonSL}}₋₁} be the set of slots in range 0 . . . 2^{μ}×10240−1, excluding S-SSB slots and non-SL slots. The slots are arranged in ascending order of the slot index.
      ii. The number of reserved slots is given by: N_{reserved}=(2^{μ}×10240−N_{S-SSB}−N_{nonsL}) mod L_{bitmap}.
      iii. The reserved slots l_{T} are given by:

$$r = ⌊ \frac{m \cdot ( {2}^{μ} \times 10240 - {N}_{S - SSB} - {N}_{n o n S L} )}{{N}_{r e s e r v e d}} ⌋ ,$$

where, m=0, 1, . . . , N_{reserved}−1.
iv. Tₘₐₓ is given by: Tₘₐₓ=24×10240−N_{S-SSB}−N_{nonSL}−N_{reserved}.
2. The slots are arranged in ascending order of slot index.
3. The set of slots belonging to the SL resource pool, {t′₀^{SL}, t′₁^{SL}, t′₂^{SL}, . . . , t′_{T′}_{_{MAX−1}}^{SL}}, are determined as follows:
   a. Each resource pool has a corresponding bitmap (b₀, b₁, . . . , b_{L}_{_{bitmap−1}}) of length Lbitmap.
   b. A slot tₖ^{SL} belongs to the SL resource pool if b_{k mod L}_{_{bitmap}}=1
   c. The remaining slots are indexed successively staring from 0, 1, . . . . T′_{MAX}−1. Where, T′_{MAX} is the number of remaining slots in the set.

Slots can be numbered (indexed) as physical slots or logical slots, wherein physical slots include slots numbered sequential, while logical slots include only slots that can be allocated to sidelink resource pool as described herein numbered sequentially. The conversion from a physical duration, Pᵣₛᵥₚ, in milli-second to logical slots, P′ᵣₛᵥₚ, is given by

$${P}_{r s v p}^{′} = ⌈ \frac{{T}_{max}^{′}}{10240 ms} \times {P}_{r s v p} ⌉$$

(see section 8.1.7 of 38.214 [4]).

For resource (re-) selection or re-evaluation in slot n, a UE can determine a set of available single-slot resources for transmission within a resource selection window [n+T₁, n+T₂], such that a single-slot resource for transmission, R_{x,y} is defined as a set of L_{subCH} contiguous subchannels x+i, where i=0, 1, . . . , L_{subCH}−1 in slot t_{y}^{SL}. T₁ is determined by the UE such that, 0≤T₁≤T_{proc,1}^{SL}, where T_{proc,1}^{SL} is a PSSCH processing time for example as defined in 3GPP standard specification, TS 38.214 [REF4] Table 8.1.4-2. T₂ is determined by the UE such that T₂ₘᵢₙ≤T₂≤Remaining Packet Delay Budget, as long as T₂ₘᵢₙ<Remaining Packet Delay Budget, else T₂ is equal to the Remaining Packet Delay Budget. T₂ₘᵢₙ is configured by higher layers and depends on the priority of the SL transmission.

The resource (re-) selection is a two-step procedure:
The first step (e.g., performed in the physical layer) is to identify the candidate resources within a resource selection window. Candidate resources are resources that belong to a resource pool, but exclude resources (e.g., resource exclusion) that were previously reserved, or reserved by other UEs. The resources excluded are based on SCIs decoded in a sensing window and for which the UE measures a SL reference signal received power (RSRP) that exceeds a threshold. The threshold depends on the priority indicated in a SCI format and on the priority of the SL transmission. Therefore, sensing within a sensing window involves decoding the first stage SCI, and measuring the corresponding SL RSRP, wherein the SL RSRP can be based on PSCCH demodulation reference signal (DMRS) or PSSCH DMRS. Sensing is performed over slots where the UE doesn't transmit SL. The resources excluded are based on reserved transmissions or semi-persistent transmissions that can collide with the excluded resources or any of reserved or semi-persistent transmissions. The identified candidate resources after resource exclusion are provided to higher layers.
The second step (e.g., performed in the higher layers) is to select or re-select a resource from the identified candidate resources for PSSCH/PSCCH transmission.

During the first step of the resource (re-) selection procedure, a UE can monitor slots in a sensing window [n−T₀, n−T_{proc,0}^{SL}), where the UE monitors slots belonging to a corresponding sidelink resource pool that are not used for the UE's own transmission. For example, T_{proc,0}^{SL} is the sensing processing latency time, for example as defined in 3GPP standard specification, TS 38.214[REF4] Table 8.1.4-1. To determine a candidate single-slot resource set to report to higher layers, a UE excludes (e.g., resource exclusion) from the set of available single-slot resources for SL transmission within a resource pool and within a resource selection window, the following:
1. Single slot resource R_{x,y}, such that for any slot t′ₘ^{SL} not monitored within the sensing window with a hypothetical received SCI Format 1-0, with a “Resource reservation period” set to any periodicity value allowed by a higher layer parameter reservationPeriodAllowed, and indicating sub-channels of the resource pool in this slot, satisfies condition 2.2. below.
2. Single slot resource R_{x,y}, such that for any received SCI within the sensing window:
1. The associated L1-RSRP measurement is above a (pre-) configured SL-RSRP threshold, where the SL-RSRP threshold depends on the priority indicated in the received SCI and that of the SL transmission for which resources are being selected.
2. (Condition 2.2) The received SCI in slot t′ₘ^{SL}, or if “Resource reservation field” is present in the received SCI the same SCI is assumed to be received in slot

$${t}_{m + q \times {P}_{rsvp \_ Rx}^{′}}^{′ S L} ,$$

indicates a set of resource blocks that overlaps

$${R}_{x , y + j \times {P}_{rsvp \_ Tx}^{′}}$$

Where,
   q=1,2, . . . , Q, where,
   If P_{rsvp_RX}≤T_{scal} and

$${n}^{′} - m < {P}_{rsvp \_ Rx}^{′} \to Q = ⌈ \frac{{T}_{s c a l}}{{P}_{rsvp \_ RX}} ⌉ . {T}_{s c a l}$$

is T₂ in units of milli-seconds.
Else, Q=1.
If n belongs to (t′₀^{SL}, t′₁^{SL}, . . . , t_{T′}_{ₘₐₓ₋₁}^{SL}), n=n′ is the first slot after slot n belonging to set (t′₀^{SL}, t′₁^{SL}, . . . , t′_{T′}_{ₘₐₓ₋₁}^{SL}).
j=0, 1, . . . , Cᵣₑₛₑₗ−1.
P_{rsvp_RX} is the indicated resource reservation period in the received SCI in physical slots, and P′_{rsvp_Rx} is that value converted to logical slots.
P′_{rsvp_Tx} is the resource reservation period of the SL transmissions for which resources are being reserved in logical slots.
3. If the candidate resources are less than a (pre-) configured percentage given by higher layer parameter sl_TxPrecentageList (prio_{TX}) that depends on the priority of the SL transmission prio_{TX}, such as 20%, of the total available resources within the resource selection window, the (pre-) configured SL-RSRP thresholds are increased by a predetermined amount, such as 3 dB.

NR sidelink introduced two new procedures for mode 2 resource allocation; re-evaluation and pre-emption.

Re-evaluation check occurs when a UE checks the availability of pre-selected SL resources before the resources are first signaled in an SCI Format, and if needed re-selects new SL resources. For a pre-selected resource to be first-time signaled in slot m, the UE performs a re-evaluation check at least in slot m−T₃. The re-evaluation check includes:
Performing the first step of the SL resource selection procedure as defined in the 3GPP specifications [i.e., TS 38.214 [REF4] clause 8.1.4], which involves identifying a candidate (available) sidelink resource set in a resource selection window as previously described.
If the pre-selected resource is available in the candidate sidelink resource set, the resource is used/signaled for sidelink transmission.
Else, the pre-selected resource is not available in the candidate sidelink resource set, a new sidelink resource is re-selected from the candidate sidelink resource set.

Pre-emption check occurs when a UE checks the availability of pre-selected SL resources that have been previously signaled and reserved in an SCI Format, and if needed re-selects new SL resources. For a pre-selected and reserved resource to be signaled in slot m, the UE performs a pre-emption check at least in slot m−T₃. When pre-emption check is enabled by higher layers, pre-emption check includes:
Performing the first step of the SL resource selection procedure as defined in the 3GPP specifications [i.e., TS 38.214 [REF4] clause 8.1.4], which involves identifying candidate (available) sidelink resource set in a resource selection window as previously described.
If the pre-selected and reserved resource is available in the candidate sidelink resource set, the resource is used/signaled for sidelink transmission.
Else, the pre-selected and reserved resource is NOT available in the candidate sidelink resource set. The resource is excluded from the candidate resource set due to an SCI, associated with a priority value P_{RX}, having an RSRP exceeding a threshold. Let the priority value of the sidelink resource being checked for pre-emption be P_{TX}.
   If the priority value P_{RX} is less than a higher-layer configured threshold and the priority value P_{RX} is less than the priority value P_{TX}. The pre-selected and reserved sidelink resource is pre-empted. A new sidelink resource is re-selected from the candidate sidelink resource set. Note that, a lower priority value indicates traffic of higher priority.
   Else, the resource is used/signaled for sidelink transmission.

In one example, a UE determines a power, P_{S-SSB}(i), in dBm, for an S-SS/PSBCH block (S-SSB) transmission occasion in slot i on an active SL BWP b of a carrier f, as:

P_{S-SSB}(i)=min (P_{CMAX}, P_{O,S-SSB}+10 log₁₀(2^{μ·M}_{RB}^{S-SSB})+α_{S-SSB}·PL)

where,
P_{CMAX} is the configured maximum output power of the UE [TS 38.101].
P_{O,S-SSB} is the PO value for DL pathloss (PL) based power control for PSBCH. If dl-P0-PSBCH-r17 is configured and supported by the UE it is used for P_{O,S-SSB}, else if dl-P0-PSBCH-r16 is configured it is used for P_{O,S-SSB}, else DL pathloss based power control for PSBCH is disabled, i.e., P_{S-SSB}(i)=P_{CMAX}.
   dl-P0-PSBCH-r16 has a range of −16 . . . 15.
   dl-P0-PSBCH-r17 has a range of −202 . . . 24.
μ is the sub-carrier spacing configuration as previously described.
M_{RB}^{S-SSB} is the number of resource blocks for S-SS/PSBCH block transmission. M_{RB}^{S-SSB}=11.
α_{S-SSB} is the alpha value for DL pathloss based power control for PSBCH. This is provided by higher layer parameter dl-Alpha-PSBCH-r16 and is 1 if that parameter is not configured. dl-Alpha-PSBCH-r16 is a value from the set {0, 0.4, 0.5, 0.6, 0.7, 0.8, 0.9, 1}.
PL is the pathloss, which is given by PL=PL_{b,f,c}(q_{d}) when the active SL BWP is on serving cell c. The RS resource q_{d} for determining the pathloss is given by:
   When the UE is configured to monitor physical downlink control channel (PDCCH) for detection of DCI Format 0_0 in serving cell c: RS resource used for determining the power of a physical uplink shared channel (PUSCH) transmission scheduled by DCI Format 0_0 in serving cell c.
   When the UE is not configured to monitor PDCCH for detection of DCI Format 0_0 in serving cell c: RS resource corresponding to SS/PBCH block used by the UE to obtain the master information block (MIB).

In one example, a UE determines a power, P_{PSSCH}(i), in dBm, for a PSSCH transmission occasion i of a resource pool, on an active SL BWP b of a carrier f, and in symbols where PSCCH is not transmitted as:

P_{PSSCH}(i)=min (P_{CMAX}, P_{MAX,CBR}, min (P_{PSSCH,D}(i), P_{PSSCH,SL}(i)))

where,
P_{CMAX} is the configured maximum output power of the UE [TS 38.101].
P_{MAX,CBR} is determined based on the priority level and a CBR range for a CBR measured in slot i−N. Where, N is the congestion control processing time [TS 38.214 [REF4]].
P_{PSSCH,D}(i) is the component for DL based power control for PSSCH. Which is given by:
   If dl-P0-PSSCH-PSCCH is provided: P_{PSSCH,D}(i)=P_{O,D}+10 log₁₀ (2^{μ}·M_{RB}^{PSSCH}(i))+α_{D}·PL_{D}.
   If dl-P0-PSSCH-PSCCH is not provided: P_{PSSCH,D}(i)=min (P_{CMAX}, P_{MAX,CBR}).
   P_{O,D} is the P0 value for DL pathloss based power control for PSSCH/PSCCH. If dl-P0-PSSCH-PSCCH-r17 is configured and supported by the UE it is used for P_{O,D}, else if dl-P0-PSSCH-PSCCH-r16 is configured it is used for P_{O,D}, else DL pathloss based power control for PSSCH/PSCCH is disabled.
      dl-P0-PSSCH-PSCCH-r16 has a range of −16 . . . 15.
      dl-P0-PSSCH-PSCCH-r17 has a range of −202 . . . 24.
   μ is the sub-carrier spacing configuration as previously described.
   M_{RB}^{PSSCH}(i) is the number of resource blocks for PSSCH transmission occasion i.
   α_{D} is the alpha value for DL pathloss based power control for PSSCH/PSCCH. This is provided by higher layer parameter dl-Alpha-PSSCH-PSCCH-r16, and is 1if that parameter is not configured. dl-Alpha-PSSCH-PSCCH-r16 is a value from the set {0, 0.4, 0.5, 0.6, 0.7, 0.8, 0.9, 1}.
   PL_{D} is the DL pathloss, which is given by PL_{D}=PL_{b,f,c}(q_{d}) when the active SL BWP is on serving cell c. The RS resource q_{d} for determining the pathloss is given by:
      When the UE is configured to monitor PDCCH for detection of DCI Format 0_0 in serving cell c: RS resource used for determining the power of a PUSCH transmission scheduled by DCI Format 0_0 in serving cell c.
      When the UE is not configured to monitor PDCCH for detection of DCI Format 0_0 in serving cell c: RS resource corresponding to SS/PBCH block used by the UE to obtain the MIB.
P_{PSSCH,SL}(i) is the component for SL based power control for PSSCH. Which is given by:
   If sl-P0-PSSCH-PSCCH is provided: P_{PSSCH,SL}(i)=P_{O,SL}+10 log₁₀ (2^{μ}·M_{RB}^{PSSCH}(i))+α_{SL}·PL_{SL}.
   If sl-P0-PSSCH-PSCCH is not provided: P_{PSSCH,SL}(i)=min (P_{CMAX}, P_{PSSCH,D}(i)
   P_{O,SL} is the P0 value for SL pathloss based power control for PSSCH/PSCCH. If sl-P0-PSSCH-PSCCH-r17 is configured and supported by the UE it is used for P_{O,SL}, else if sl-P0-PBSCH-r16 is configured it is used for P_{O,SL}, else SL pathloss based power control for PSSCH/PSCCH is disabled.
      sl-P0-PSSCH-PSCCH-r16 has a range of −16 . . . 15.
      sl-P0-PSSCH-PSCCH-r17 has a range of −202 . . . 24.
   μ is the sub-carrier spacing configuration as previously described.
   M_{RB}^{PSSCH}(i) is the number of resource blocks for PSSCH transmission occasion i.
   α_{SL} is the alpha value for SL pathloss based power control for PSSCH/PSCCH. This is provided by higher layer parameter sl-Alpha-PSSCH-PSCCH-r16 and is 1 if that parameter is not configured. sl-Alpha-PSSCH-PSCCH-r16 is a value from the set {0, 0.4, 0.5, 0.6, 0.7, 0.8, 0.9, 1}.
   PL_{SL} is the SL pathloss, which is given by PL_{SL}=referenceSignalPower—higher layer filtered RSRP:
      referenceSignalPower is obtained by summing the PSSCH transmit power per RE over antenna ports and higher layer filtered across PSSCH transmission occasions using filter configuration provided by sl-FilterCoefficient.
      “higher layer filtered RSRP” is the SL RSRP measured by the UE receiving the PSSCH/PSCCH transmissions and reported to the UE that transmitted PSSCH/PSCCH. The SL RSRP is measured on PSSCH DMRS and filtered across PSSCH transmission occasions using filter configuration provided by sl-FilterCoefficient.

The UE splits its power equally among antenna ports that have non-zero power.

In one example, in symbols where PSSCH and PSCCH are transmitted, a UE determines a power, P_{PSSCH2}(i), in dBm, for a PSSCH transmission occasion i of a resource pool, on an active SL BWP b of a carrier f, and in symbols where PSSCH and PSCCH are transmitted as:

$${P}_{P S S C H 2} ( i ) = 10 {log}_{10} ( \frac{{M}_{R B}^{P S S C H} ( i ) - {M}_{R B}^{P S C C H} ( i )}{{M}_{R B}^{P S S C H} ( i )} ) + {P}_{P S S C H} ( i )$$

where,
M_{RB}^{PSSCH}(i) is the number of resource blocks for PSSCH transmission occasion i.
M_{RB}^{PSCCH}(i) is the number of resource blocks for PSCCH transmission occasion i.
P_{PSSCH}(i) is the PSSCH power in symbols with no PSCCH.

In one example, a UE determines a power, P_{PSCCH}(i), in dBm, for a PSCCH

transmission occasion i of a resource pool, on an active SL BWP b of a carrier f, as:

$${P}_{P S C C H} ( i ) = 10 {log}_{I 0} ( \frac{{M}_{R B}^{P S C C H} ( i )}{{M}_{R B}^{P S S C H} ( i )} ) + {P}_{P S S C H} ( i )$$

where,
M_{RB}^{PSSCH}(i) is the number of resource blocks for PSSCH transmission occasion i.
M_{RB}^{PSCCH}(i) is the number of resource blocks for PSCCH transmission occasion i.
P_{PSSCH}(i) is the PSSCH power in symbols with no PSCCH.

In one example, a UE has N_{sch,TX,PSFCH} scheduled PSFCH transmissions for HARQ-ACK information and conflict information. The UE is capable of transmitting a maximum of N_{max,PSFCH}. The UE determines N_{TX,PSFCH} PSFCH to transmit, each with a power P_{PSFCH,k} (i), for 1≤k≤N_{TX,PSFCH}, for a PSFCH transmission occasion i of a resource pool, on an active SL BWP b of a carrier f. A UE can be provided with higher layer parameter dl-P0-PSFCH for P0 for DL pathloss based power control for PSFCH. The UE calculates P_{PSFCH,one} in dBm:

$${P}_{PSFCH , one} = {P}_{O , PSFCH} + 10 {log}_{10} ( {2}^{μ} ) + {α}_{PSFCH} \cdot PL$$

where,
P_{O,PSECH} is the P0 value for DL pathloss based power control for PSFCH. If dl-P0-PSFCH-r17 is configured and supported by the UE it is used for P_{O,PSFCH}, else if dl-P0-PSFCH-r16 is configured it is used for P_{O,PSFCH}, else DL pathloss based power control for PSFCH is disabled, i.e., P_{PSFCH,k}(i)=P_{CMAX}−10 log₁₀(N_{TX,PSFCH}), where P_{CMAX} is determined for N_{TX,PSFCH} transmissions.
   dl-P0-PSFCH-r16 has a range of −16 . . . 15.
   dl-P0-PSFCH-r17 has a range of −202 . . . 24.
μ is the sub-carrier spacing configuration as previously described.
α_{PSFCH} is the alpha value for DL pathloss based power control for PSFCH. This is provided by higher layer parameter dl-Alpha-PSFCH-r16, and is 1 if that parameter is not configured. dl-Alpha-PSFCH-r16 is a value from the set {0, 0.4, 0.5, 0.6, 0.7, 0.8, 0.9, 1}.
PL is the pathloss, which is given by PL=PL_{b,f,c}(q_{d}) when the active SL BWP is on serving cell c. The RS resource q_{d} for determining the pathloss is given by:
   When the UE is configured to monitor PDCCH for detection of DCI Format 0_0 in serving cell c: RS resource used for determining the power of a PUSCH transmission scheduled by DCI Format 0_0 in serving cell c.
When the UE is not configured to monitor PDCCH for detection of DCI Format 0_0 in serving cell c: RS resource corresponding to SS/PBCH block used by the UE to obtain the MIB.

As described above, the monitoring procedure for resource (re) selection during the sensing window requires reception and decoding of a SCI format during the sensing window as well as measuring the SL RSRP. This reception and decoding process and measuring the SL RSRP increases a processing complexity and power consumption of a UE for sidelink communication and requires the UE to have receive circuitry on the SL for sensing even if the UE only transmits and does not receive on the sidelink. The aforementioned sensing procedure is referred to a full sensing.

Rel-17 introduced low-power resource allocation. Low-power resource allocation schemes include partial sensing and random resource selection. If a SL transmission from a UE is periodic, partial sensing can be based on periodic-based partial sensing (PBPS), and/or contiguous partial sensing (CPS). If a SL transmission from a UE is aperiodic, partial sensing can be based on CPS and PBPS if the resource pool supports periodic reservations (i.e., sl_multiReserveResource is enabled). When a UE performs PBPS, the UE selects a set of Y slots (Y≥Yₘᵢₙ) within a resource selection window corresponding to PBPS, where Yₘᵢₙ is provided by higher layer parameter minNumCandidateSlotsPeriodic. . . . The UE monitors slots at t′_{y-k×P}_{ᵣₑₛₑᵣᵥₑ}, where t′_{y}^{SL} is a slot of the Y selected candidate slots. The periodicity value for sensing for PBPS, i.e., Pᵣₑₛₑᵣᵥₑ is a subset of the resource reservation periods allowed in a resource pool provided by higher layer parameter sl-ResourceReservePeriodList. Pᵣₑₛₑᵣᵥₑ is provided by higher layer parameter periodicSensingOccasionReservePeriodList, if not configured, Pᵣₑₛₑᵣᵥₑ includes periodicities in sl-ResourceReservePeriodList. The UE monitors k sensing occasions determined by additionalPeriodicSensingOccasion, as previously described, and not earlier than n-T₀. For a given periodicity Pᵣₑₛₑᵣᵥₑ, the values of k correspond to the most recent sensing occasion earlier than t′_{y0}^{SL}−(T_{proc,0}^{SL}+T_{proc,1}^{SL}) if additionalPeriodicSensingOccasion is not (pre-) configured and additionally includes the value of k corresponding to the last periodic sensing occasion prior to the most recent one if additionalPeriodicSensingOccasion is (pre-) configured. t′_{y0}^{SL} is the first slot of the selected Y candidate slots of PBPS. When a UE performs CPS, the UE selects a set of Y′ slots (Y′≥Y′ₘᵢₙ) within a resource selection window corresponding to CPS, where Yₘᵢₙ is provided by higher layer parameter minNumCandidateSlotsAperiodic. The sensing window for CPS starts at least M logical slots before t′_{y0}^{SL} (the first of the Y′ candidate slots) and ends at t′_{y0}^{SL}-(T_{proc,0}^{SL}+T_{proc,1}^{SL}).

Rel-17 introduced inter-UE co-ordination (IUC) to enhance the reliability and reduce the latency for resource allocation, where SL UEs exchange information with one another over sidelink to aid the resource allocation mode 2 (re-) selection procedure. UE-A (e.g., UE 111) provides information to UE-B (e.g., UE 111B), and UE-B uses the provided information for its resource allocation mode 2 (re-) selection procedure. IUC addresses is designed to address issues with distributed resource allocation such as: (1) Hidden node problem, where a UE-B is transmitting to a UE-A and UE-B can't sense or detect transmissions from a UE-C (e.g., UE 111C), that interfere with its transmission to a UE-A, (2) Exposed node problem, where a UE-B is transmitting to a UE-A, and UE-B senses or detects transmissions from a UE-C and avoids the resources used or reserved by UE-C, but UE-C doesn't cause interference at UE-A, (3) Persistent collision problem, and (4) Half-duplex problem, where UE-B is transmitting to a UE-A in the same slot that UE-A is transmitting. UE-A will miss the transmission from UE-B as it can't receive and transmit in the same slot.

There are two schemes for inter-UE co-ordination, as described herein.

In one example, in scheme 1, a UE-A can provide to another UE-B indications of resources that are preferred to be included in UE-B's (re-) selected resources or non-preferred resources to be excluded for UE-B's (re-) selected resources. When given preferred resources, UE-B may use only on those resources for its resource (re-) selection, or it may combine them with resources identified by its own sensing procedure, by finding the intersection of the two sets of resources, for its resource (re-) selection. When given non-preferred resources, UE-B may exclude these resources from resources identified by its own sensing procedure for its resource (re-) selection. Transmissions of co-ordination information (e.g., IUC messages) sent by UE-A to UE-B, and co-ordination information requests for (e.g., IUC requests) sent by UE-B to UE-A, are sent in a MAC-control element (CE) message and may also, if the supported by the UE, be sent in a 2^{nd}-stage SCI Format (SCI Format 2-C). The benefit of using the 2nd stage SCI is to reduce latency. IUC messages from UE-A to UE-B can be sent standalone, or can be combined with other SL data. Coordination information (IUC messages) can be in response to a request from UE-B, or due to a condition at UE-A. An IUC request is unicast from UE-B to UE-A, in response UE-A sends an IUC message in unicast mode to UE-B. An IUC message transmitted as a result of an internal condition at UE-A can be unicast to UE-B, when it includes preferred resources,, or can be unicast, groupcast or broadcast to UE-B when it includes non-preferred resources. UE-A can determine preferred or non-preferred resources for UE-B based on its own sensing taking into account the SL-RSRP measurement of the sensed data and the priority of the sensed data, i.e., the priority field of the decoded PSCCH during sensing as well as the priority the traffic transmitted by UE-B in case of request-based IUC or a configured priority in case of condition-based IUC. Non-preferred resource to UE-B can also be determined to avoid the half-duplex problem, where UE-A can't receive data from a UE-B in the same slot UE-A is transmitting.

In another example, in scheme 2, a UE-A can provide to another UE-B an indication that resources reserved for UE-B's transmission, whether or not UE-A is the destination UE, are subject to conflict with a transmission from another UE. UE-A determines the conflicting resources based on the priority and RSRP of the transmissions involved in the conflict. UE-A can also determine a presence of a conflict due to the half-duplex problem, where UE-A can't receive a reserved resource from UE-B at the same time UE-A is transmitting. When UE-B receives a conflict indication for a reserved resource, it can re-select new resources to replace them. The conflict information from UE-A is sent in a PSFCH channel separately (pre-) configured from the PSFCH of the PSFCH of SL-HARQ operation, The timing of the PSFCH channel carrying conflict information can be based on the SCI indicating reserved resource, or based on the reserved resource.

In both schemes, UE-A can identify resources according to a number of conditions which are based on the SL-RSRP of the resources in question as a function of the traffic priority, and/or whether UE-A would be unable to receive a transmission from UE-B, due to performing its own transmission, i.e., a half-duplex problem. The purpose of this exchange of information is to give UE-B information about resource occupancy acquired by UE-A which it cannot determine on its own due to hidden nodes, exposed nodes, persistent collisions, etc.

3GPP Release 16 is the first NR release to include sidelink through work item “5G V2X with NR sidelink”, the mechanisms introduced focused mainly on vehicle-to-everything (V2X) and can be used for public safety when the service requirement can be met. Release 17extends sidelink support to more use cases through work item “NR Sidelink enhancement” (RP-201385). The objectives of Rel-17 SL include: (1) Resource allocation enhancements that reduce power consumption and (2) enhanced reliability and reduced latency.

Rel-17 introduced low-power resource allocation. Low-power resource allocation schemes include partial sensing and random resource selection. If a SL transmission from a UE is periodic, partial sensing can be based on periodic-based partial sensing (PBPS), and/or contiguous partial sensing (CPS). If a SL transmission from a UE is aperiodic, partial sensing can be based on CPS and PBPS if the resource pool supports periodic reservations (i.e., sl_multiReserveResource is enabled). When a UE performs PBPS, the UE selects a set of Y slots (Y≥Yₘᵢₙ) within a resource selection window corresponding to PBPS, where Yₘᵢₙ is provided by higher layer parameter minNumCandidate SlotsPeriodic. The UE monitors slots at t′_{y-k×P}_{ᵣₑₛₑᵣᵥₑ}^{SL}, where t′_{y}^{SL} is a slot of the Y selected candidate slots. The periodicity value for sensing for PBPS, i.e., Pᵣₑₛₑᵣᵥₑ is a subset of the resource reservation periods allowed in a resource pool provided by higher layer parameter sl-ResourceReservePeriodList. Pᵣₑₛₑᵣᵥₑ is provided by higher layer parameter periodicSensingOccasionReservePeriodList. If not configured, Pᵣₑₛₑᵣᵥₑ includes periodicities in sl-ResourceReservePeriodList. The UE monitors k sensing occasions determined by additionalPeriodicSensingOccasion, as previously described, and not earlier than n-T₀. For a given periodicity Pᵣₑₛₑᵣᵥₑ, the values of k correspond to the most recent sensing occasion earlier than t′_{y0}^{SL}−(T_{proc,0}^{SL}+T_{proc,1}^{SL}) if additionalPeriodicSensingOccasion is not (pre-) configured and additionally includes the value of k corresponding to the last periodic sensing occasion prior to the most recent one if additionalPeriodicSensingOccasion is (pre-) configured. t′_{y0}^{SL} is the first slot of the selected Y candidate slots of PBPS. When a UE performs CPS, the UE selects a set of Y′ slots (Y′≥Y′min) within a resource selection window corresponding to CPS, where Y′ₘᵢₙ is provided by higher layer parameter minNumCandidateSlotsAperiodic. The sensing window for CPS starts at least M logical slots before t′_{y0}^{SL} (the first of the Y′ candidate slots) and ends at t′_{y0}^{SL}-(T_{proc,0}^{SL}+T_{proc,1}^{SL}).

Rel-17 introduced inter-UE co-ordination (IUC) to enhance the reliability and reduce the latency for resource allocation, where SL UEs exchange information with one another over sidelink to aid the resource allocation mode 2 (re-) selection procedure. UE-A provides information to UE-B, and UE-B uses the provided information for its resource allocation mode 2 (re-) selection procedure. IUC is designed to address issues with distributed resource allocation such as: (1) Hidden node problem, where a UE-B is transmitting to a UE-A and UE-B can't sense or detect transmissions from a UE-C that interfere with its transmission to a UE-A, (2) Exposed node problem, where a UE-B is transmitting to a UE-A, and UE-B senses or detects transmissions from a UE-C and avoids the resources used or reserved by UE-C, but UE-C doesn't cause interference at UE-A, (3) Persistent collision problem, and (4) Half-duplex problem, where UE-B is transmitting to a UE-A in the same slot that UE-A is transmitting in, UE-A will miss the transmission from UE-B as UE-A cannot receive and transmit in the same slot. There are two schemes for inter-UE co-ordination:
1. In one example, in scheme 1, a UE-A can provide to another UE-B indications of resources that are preferred to be included in UE-B's (re-) selected resources, or non-preferred resources to be excluded for UE-B's (re-) selected resources. When given preferred resources, UE-B may use only those resources for its resource (re-) selection, or UE-B may combine them with resources identified by its own sensing procedure, e.g., by finding the intersection of the two sets of resources, for its resource (re-) selection. When given non-preferred resources, UE-B may exclude these resources from resources identified by its own sensing procedure for its resource (re-) selection.
Transmissions of co-ordination information (e.g., IUC messages) sent by UE-A to UE-B, and co-ordination information requests (e.g., IUC requests) sent by UE-A to UE-B, are sent in a MAC-CE message and may also, if supported by the UEs, be sent in a 2^{nd}-stage SCI Format (SCI Format 2-C). The benefit of using the 2nd stage SCI is to reduce latency. IUC messages from UE-A to UE-B can be sent standalone or can be combined with other SL data. Coordination information (IUC messages) can be in response to a request from UE-B, or due to a condition at UE-A. An IUC request is unicast from UE-B to UE-A, in response UE-A sends an IUC message in unicast mode to UE-B. An IUC message transmitted as a result of an internal condition at UE-A can be unicast to UE-B, when the IUC message includes preferred resources, or can be unicast, groupcast or broadcast to UE-B when the IUC message includes non-preferred resources. UE-A can determine preferred or non-preferred resources for UE-B based on its own sensing taking into account the SL-RSRP measurement of the sensed data and the priority of the sensed data, i.e., the priority field of the decoded PSCCH during sensing as well as the priority the traffic transmitted by UE-B in case of request-based IUC or a configured priority in case of condition-based IUC. Non-preferred resource to UE-B can also be determined to avoid the half-duplex problem, where UE-A can't receive data from a UE-B in the same slot UE-A is transmitting.
2. In another example, in scheme 2, a UE-A can provide to another UE-B an indication that resources reserved for UE-B's transmission, whether or not UE-A is the destination UE of these resources, are subject to conflict with a transmission from another UE. UE-A determines the conflicting resources based on the priority and RSRP of the transmissions involved in the conflict. UE-A can also determine a presence of a conflict due to the half-duplex problem, where UE-A can't receive a reserved resource from UE-B at the same time UE-A is transmitting. When UE-B receives a conflict indication for a reserved resource, UE-B can re-select new resources to replace them.

The conflict information from UE-A is sent in a PSFCH channel separately (pre-) configured from the PSFCH of the SL-HARQ operation. The timing of the PSFCH channel carrying conflict information can be based on the SCI indicating reserved resource or based on the reserved resource.

In both schemes, UE-A can identify resources according to a number of conditions which are based on the SL-RSRP of the resources in question as a function of the traffic priority, and/or whether UE-A would be unable to receive a transmission from UE-B, due to performing its own transmission, i.e., a half-duplex problem. The purpose of this exchange of information is to give UE-B information about resource occupancy acquired by UE-A which UE-B cannot determine on its own due to hidden nodes, exposed nodes, persistent collisions, etc.

Release 18 considers further evolution of the NR SL air interface for operation in unlicensed bands, beam-based operation in FR2, SL carrier aggregation and co-channel co-existence between LTE SL and NR SL.

For LTE SL, a UE can operate with SL CA for some modes of resource allocation (modes 3 and 4). When operating in CA, a given (sidelink) MAC protocol data unit (PDU) is transmitted, and if necessary re-transmitted, on a single sidelink carrier, and multiple MAC PDUs can be transmitted in parallel on different carriers. This provides a throughput gain in a similar way as for Uu CA. The UE allowed to transmit and receive on multiple sidelink carriers (pre) configured by the network can select specific sidelink one or more carriers among them for transmission.

SL CA for resource allocation mode 3 using a dynamic grant is similar to the CA operation on the Uu interface that includes a carrier indication field (CIF) in the DCI from the eNB. This indicates which among the up to 8 configured sidelink carriers the allocation in the DCI applies to.

SL CA in resource allocation mode 4 uses a sensing procedure to select resources independently on each involved carrier. The same carrier is used for MAC PDUs of the same SL process at least until the process triggers resource re-selection. Procedures to avoid unexpected UE behavior when the demands of CA become high allow a UE to drop a transmission which uses an excessive amount of resources or transmit chains, or to reject and re-select resources for which it cannot meet the RF requirements under CA.

SL synchronization can also operate on multiple carriers. In addition, in sidelink CA operation, a SyncRef UE uses a single synchronization reference for aggregated carriers and may transmit a sidelink synchronization signal/physical sidelink broadcast channel (SLSS/PSBCH) on one or multiple of them according to capability. A receiving UE likewise uses the same synchronization reference (not necessarily a SyncRef UE) for its aggregated carriers, and it uses the highest priority synchronization reference present among the available synchronization carriers. Another form of CA is packet data convergence protocol (PDCP) duplication, where the same PDCP packet is transmitted in parallel on multiple sidelink carriers, to increase reliability.

SL power control can be based on DL-based open loop control power and SL-based open loop power control. Open loop power control uses the pathloss estimate between the gNB and transmitting SL UE (for DL-based open loop-based power control) and the pathloss estimate between the transmitting SL UE and the receiving SL UE (for SL-based open loop-based power control) to determine the transmit power of the SL transmitting UE.

The transmitting SL UE and the receiving SL UE can be configured for operation with carrier aggregation with multiple carriers for SL (e.g., PC5) interface. The transmitting SL UE transmits on a first number of carriers and receive on a second number of carriers. The first and second number of carriers can be the same or different, and can be 1 or larger. When the UE uses more than one carrier for SL transmission or reception, the transmission or reception on one carrier may overlap in time with the transmission or reception on another carrier. The overlap may occur for a portion of the transmission or reception or for the whole duration of the transmission or reception. Thus, there is a need to determine the transmit powers of the multiple SL transmissions when the UE transmits on more than one carrier.

A transmitting UE and a receiving UE can transmit and receive on a same carrier and use multiple carriers simultaneously to transmit and receive. The transmitting UE and the receiving UE can also use different carriers to transmit and receive. For example, for a pair of UEs, UE1 and UE2, UE1 transmit to UE2 on a first set of one or more carriers and receives from UE2 on a second set of one or more carriers, and first and second set of carriers include different carriers. Thus, there is another need to determine the transmit powers of the multiple SL transmissions when UE1 and UE2 use different carriers for transmission.

A UE operating with SL CA can transmit in each carrier a PSFCH to provide HARQ-ACK information and/or conflict information corresponding to a reception on the same carrier and can determine the power of the physical sidelink feedback channel (PSFCH) in each carrier based on a DL open loop power control and/or a SL open loop power control for the same carrier. When the UE transmits multiple PSFCHs on a same carrier and the multiple PSFCHs provide HARQ-ACK information and/or conflict information corresponding to other carriers, the transmit power of the PSFCHs can be determined based on the DL open loop power control or can be determined based on the DL open loop power control and the SL-based open loop power control for each corresponding carrier. Thus, there is another need to determine the transmit powers of the PSFCHs corresponding to the multiple carriers when the PSFCHs are transmitted on the corresponding carriers or on a different carrier than the carrier associated with the provided information.

A UE can be configured with SL CA and operate with a closed loop power control. Thus, there is another need to determine the transmit power of the transmitting SL UE when the UE operates with SL CA and closed loop power control on one or more of the carriers.

The present disclosure relates to transmissions and receptions for a transmitting SL UE and a receiving SL UE operating with carrier aggregation. The present disclosure relates to determining the transmit powers of the multiple SL transmissions when the UE transmits on more than one carrier. The present disclosure also relates to determining the transmit powers of the multiple SL transmissions when a pair of UEs use different carriers for transmission (and reception). The present disclosure also relates to determining the transmit powers of the PSFCHs corresponding to the multiple carriers when the PSFCHs are transmitted on the corresponding carriers or on a different carrier than the carrier associated with the provided information. The present disclosure further relates to determining the transmit power of the transmitting SL UE when the UE operates CA and with closed loop power control.

For sidelink transmissions, an open-loop power control scheme can be used, and a receiving UE does not inform a transmitting UE to increase or decrease the transmission power level. In a first example, the receiving UE can measure an RSRP of a reference signal, for example a DM-RS on a PSSCH, and report the measurement through higher layer signaling to the transmitting UE that can estimate a pathloss of the sidelink transmissions. In a second example the transmitting UE estimates the sidelink pathloss used to determine the power of the sidelink transmissions to be received by the receiving UE from measurements of a reference signal transmitted by the receiving UE. In a third example the transmitting UE estimates the sidelink pathloss using both RSRP measurements of the first and second examples.

To determine the transmission power, based on a configuration the transmitting UE can use only the downlink pathloss (between transmitting UE and gNB), only the sidelink pathloss (between transmitting UE and receiving UE), or both downlink pathloss and sidelink pathloss. The configuration can be the same for PSSCH, PSSCH and PSFCH, resulting in the same power for symbols used for PSSCH, PSSCH and PSFCH in a slot, or can be different. For example, a first configuration to use both the sidelink pathloss and the downlink pathloss can apply to the transmit power control of PSSCH and PSCCH, and a second configuration to use the downlink pathloss can apply to the transmit power control of PSFCH. For the UE configured to use both downlink pathloss and sidelink pathloss to determine the transmission power of the sidelink channel(s), the transmission power can be determined as the minimum (or the maximum) value among the sidelink transmission power derived from the sidelink pathloss, and the downlink transmission power derived from the downlink pathloss.

When the transmission power is determined, the total sidelink transmission power is the same in the symbols used for PSCCH and PSSCH transmissions in a slot. For the transmission power of PSFCH, an open-loop power control is also adopted in which a receiving UE estimates a pathloss from a gNB to determine the transmission power. A transmitting UE may provide its location information to the receiving UE (conveyed by the 2nd-stage SCI. The receiving UE may not transmit ACK/NACK on the PSFCH if the pathloss is above a threshold.

The present disclosure provides power control for SL with carrier aggregation.

SL power control can be based on DL-based open loop control power, and SL-based open loop power control. Open loop power control uses the pathloss estimate between the gNB and transmitting SL UE (for DL-based open loop-based power control) and the pathloss estimate between the transmitting SL UE and the receiving SL UE (for SL-based open loop-based power control) to determine the transmit power of the SL transmitting UE.

The transmitting SL UE and the receiving SL UE can be configured for operation with carrier aggregation with multiple carriers for SL (e.g., PC5) interface. The transmitting SL UE transmits on a first number of carriers and receive on a second number of carriers. The first and second number of carriers can be the same or different, and can be 1 or larger. When the UE uses more than one carrier for SL transmission or reception, the transmission or reception on one carrier may overlap in time with the transmission or reception on another carrier. The overlap may occur for a portion of the transmission or reception, or for the whole duration of the transmission or reception. Thus, embodiments of the present disclosure recognize there is a need to determine the transmit powers of the multiple SL transmissions when the UE transmits on more than one carrier.

A transmitting UE and a receiving UE can transmit and receive on a same carrier and use multiple carriers simultaneously to transmit and receive. The transmitting UE and the receiving UE can also use different carriers to transmit and receive. For example, for a pair of UEs, UE1 and UE2, UE1 transmit to UE2 on a first set of one or more carriers and receives from UE2 on a second set of one or more carriers, and first and second set of carriers include different carriers. Thus, there is another need to determine the transmit powers of the multiple SL transmissions when UE1 and UE2 use different carriers for transmission.

A UE operating with SL CA can transmit in each carrier a PSFCH to provide HARQ-ACK information and/or conflict information corresponding to a reception on the same carrier and can determine the power of the PSFCH in each carrier based on a DL open loop power control and/or a SL open loop power control for the same carrier. When the UE transmits multiple PSFCHs on a same carrier and the multiple PSFCHs provide HARQ-ACK information and/or conflict information corresponding to other carriers, the transmit power of the PSFCHs can be determined based on the DL open loop power control or can be determined based on the DL open loop power control and the SL-based open loop power control for each corresponding carrier. Thus, there is another need to determine the transmit powers of the PSFCHs corresponding to the multiple carriers when the PSFCHs are transmitted on the corresponding carriers or on a different carrier than the carrier associated with the provided information.

A UE can be configured with SL CA and operate with a closed loop power control. Thus, there is another need to determine the transmit power of the transmitting SL UE when the UE operates with SL CA and closed loop power control on one or more of the carriers.

The present disclosure relates to transmissions and receptions for a transmitting SL UE and a receiving SL UE operating with carrier aggregation. The present disclosure relates to determining the transmit powers of the multiple SL transmissions when the UE transmits on more than one carrier. The present disclosure also relates to determining the transmit powers of the multiple SL transmissions when a pair of UEs use different carriers for transmission (and reception). The present disclosure also relates to determining the transmit powers of the PSFCHs corresponding to the multiple carriers when the PSFCHs are transmitted on the corresponding carriers or on a different carrier than the carrier associated with the provided information. The present disclosure further relates to determining the transmit power of the transmitting SL UE when the UE operates CA and with closed loop power control.

Aspects, features, and advantages of the present disclosure are readily apparent from the following detailed description, simply by illustrating a number of particular embodiments and implementations, including the best mode contemplated for carrying out the present disclosure. The present disclosure is also capable of other and different embodiments, and its several details can be modified in various obvious respects, all without departing from the spirit and scope of the present disclosure. Accordingly, the drawings and description are to be regarded as illustrative in nature, and not as restrictive. The present disclosure is illustrated by way of example, and not by way of limitation, in the figures of the accompanying drawings.

A description of example embodiments is provided on the following pages.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In SL, “reference RS” can correspond to a set of characteristics for SL beam, such as a direction, a precoding/beamforming, a number of ports, and so on. This can correspond to a SL receive beam or to a SL transmit beam. At least two UEs are involved in a SL communication. We refer to a first UE as UE-A and to second UE as UE-B. In one example, UE-A is transmitting SL data on PSSCH/PSCCH, and UE-B is receiving the SL data on PSSCH/PSCCH.

In this disclosure, RRC signaling (e.g., configuration by RRC signaling) includes the following: (1) RRC signaling over the Uu interface, this can be system information block (SIB)-based RRC signaling (e.g., SIB1 or other SIB) or RRC dedicated signaling that is sent to a specific UE, and/or (2) PC5-RRC signaling over the PC5 or SL interface.

In this disclosure MAC CE signaling includes: (1) MAC CE signaling over the Uu interface, and/or (2) MAC CE signaling over the PC5 or SL interface.

In this disclosure L1 control signaling includes: (1) L1 control signaling over the Uu interface, which can include (1a) DL control information (e.g., DCI on PDCCH) and/or (1b) UL control information (e.g., uplink control information (UCI) on physical uplink control channel (PUCCH) or PUSCH), and/or (2) SL control information over the PC5 or SL interface which can include (2a) first stage sidelink control information (e.g., first stage SCI on PSCCH), and/or (2b) second stage sidelink control information (e.g., second stage SCI on PSSCH) and/or (2c) feedback control information (e.g., control information carried on PSFCH).

In this disclosure, a carrier from the multiple carriers for SL CA can be identified for communication between a first UE and a second UE. In one example for the first UE, a same carrier is used to transmit PSSCH/PSCCH and PSFCH from the first UE to the second UE. In one example, for the first UE, a same carrier is used to receive PSSCH/PSCCH and PSFCH at the first UE from the second UE. In one example for the first UE, different carriers are used to transmit PSSCH/PSCCH and PSFCH from the first UE to the second UE. In one example, for the first UE, different carriers are used to receive PSSCH/PSCCH and PSFCH at the first UE from the second UE. In one example for the first UE, different carriers are used to transmit PSSCH and PSCCH from the first UE to the second UE. In one example, for the first UE, different carriers are used to receive PSSCH and PSCCH at the first UE from the second UE. The roles of the first and second UEs can be interchanged.

In this disclosure, without the loss of any generality, UE-A is the SL UE transmitting PSSCH/PSCCH or receiving PSFCH and UE-B is the SL UE receiving PSSCH/PSCCH or transmitting PSFCH. Communication has been established between UE-A and UE-B (e.g., for PSSCH/PSCCH or PSFCH) and a carrier or a carrier pair has been determined, e.g., UE-A transmits PSSCH/PSCCH on a first carrier and UE-B receives PSSCH/PSCCH on the first carrier or a second carrier.

As described earlier, for S-SSB, the UE can determine the transmit power based on open loop power control as

P_{S-SSB}(i)=min (P_{CMAX}, P_{O,S-SSB}+10 log₁₀ (2^{μ}·M_{RB}^{S-SSB})+α_{S-SSB}·PL)

For S-SSB, only DL-based open loop power control is used.

As described earlier, for PSSCH, the UE can determine the transmit power based on open loop power control as:

P_{PSSCH}(i)=min (P_{CMAX}, P_{MAX,CBR}, min (P_{PSSCH,D}(i), P_{PSSCH,SL}(i)))

where,
P_{PSSCH,D}(i) is the component for DL-based open loop power control, which is given by:

$${P}_{PSSCH , D} ( i ) = {P}_{O , D} , 10 {log}_{10} ( {2}^{μ} \cdot {M}_{R B}^{P S S C H} ( i ) ) + {α}_{D} \cdot {PL}_{D} .$$

P_{PSSCH,SL}(i) is the component for SL-based open power control, which is given by:

$${P}_{PSSCH , SL} ( i ) = {P}_{O , SL} , 10 {log}_{10} ( {2}^{μ} \cdot {M}_{R B}^{P S S C H} ( i ) ) + {α}_{S L} \cdot {PL}_{S L}$$

As described earlier, for one PSFCH transmission, the UE can determine the transmit power based only on DL open loop power control as:

P_{PSFCH,one}=P_{O,PSFCH}+10 log₁₀(2^{μ})+α_{PSFCH}·PL

For PSFCH, various embodiments extend PSFCH power control to include SL-based open power control at least for scenarios where the PSFCH is unicast to one UE, in which case the SL path-loss can be the pathloss between the two UEs of the unicast link. For example, the PSFCH power control equation for one transmission can be:

P_{PSFCH,one}=min (P_{PSFCH,one,D}(i), P_{PSFCH,one,SL}(i))

where,
P_{PSFCH,one,D}(i) is the component for DL-based open loop power control, which can be given by: P_{PSFCH,one,D}(i)=P_{O,D,PSFCH}+10 log₁₀(2^{μ)+α}_{D,PSFCH}·PL_{D}.
P_{PSSCH,SL}(i) is the component for SL-based open power control, which can be given by:

$${P}_{PSSCH , SL} ( i ) = {P}_{O , SL , PSFCH} + 10 {log}_{10} ( {2}^{μ} ) + {α}_{S L , P S F C H} \cdot {PL}_{S L}$$

In the aforementioned equations, the pathloss can depend on the beam used for SL transmission. The power control parameters, e.g., P0 and alpha, can be beam independent or can depend on the beam used for SL transmission. This disclosure further considers these aspects.

When a transmitting SL UE and a receiving SL UE are configured for operation with carrier aggregation with multiple carriers for SL (e.g., PC5) interface, the transmitting SL UE (UE-A) and the receiving SL UE (UE-B) transmit and receive on multiple carriers simultaneously. UE-A and UE-B can be configured with multiple carriers, and UE-A selects a first set of carriers for transmission to the receiving UE-B and UE-B selects a second set of carriers for transmission to UE-A. The selection procedure of the first and second set of carriers can include one or more of the following: gNB triggers the selection, UE-A and UE-B inform the gNB of candidate carriers for transmission or reception, gNB configures the carriers for each UE or for a pair of UEs.

The DL-based power control can depend, subject to a higher layer configuration, on the DL pathloss, which is given by PL_{D,f}=PL_{b,f,c}(q_{d}) for carrier f on the active SL BWP on serving cell c, and q_{d} is the RS resource for determining the pathloss.
PL_{b,f,c}(q_{d})=referenceSignalPower—higher layer filtered RSRP, where reference SignalPower is provided by higher layers and RSRP is defined for the reference serving cell and the higher layer filter configuration provided by QuantityConfig defined for the reference serving cell. For the RS resource q_{d} for determining the pathloss for carrier f, when the UE is configured to monitor PDCCH for detection of DCI format 0_0 in serving cell c, the RS resource is the one used for determining the power of a PUSCH transmission scheduled by DCI format 0_0in serving cell c. When the UE is not configured to monitor PDCCH for detection of DCI format 0_0 in serving cell c, the RS resource is the one corresponding to the SS/PBCH block used by the UE to obtain the MIB.

The SL-based power control can depend, subject to a higher layer configuration, on the SL pathloss, which is given for each carrier f by PL_{SL,e}=referenceSignalPower—“higher layer filtered RSRP”
The reference SignalPower is obtained by summing the PSSCH transmit power per RE over antenna ports of carrier e and higher layer filtered across PSSCH transmission occasions using filter configuration provided by sl-FilterCoefficient, which can be carrier-specific or the same for the carriers configured and/or selected for the PSSCH transmissions.
The “higher layer filtered RSRP” is the SL RSRP measured by the UE receiving the PSSCH/PSCCH transmissions and reported to the UE that transmitted PSSCH/PSCCH for carrier f. The SL RSRP is measured on PSSCH DMRS (SL RSRP is the PSCCH RSRP which is defined as the linear average over the power contributions of the resource elements that carry demodulation reference signals associated with PSCCH) and filtered across PSSCH transmission occasions using filter configuration provided by sl-FilterCoefficient.

In a first example, UE-A transmits PSSCH/PSCCH and UE-B receives PSSCH/PSCCH. UE-A estimates the SL PL as follows.
UE-A obtains reference SignalPower by summing the PSSCH transmit power per RE over antenna ports and higher layer filtered across PSSCH transmission occasions using filter configuration provided by sl-FilterCoefficient.
UE-B measures the “higher layer filtered RSRP” by measuring the SL RSRP on PSSCH DMRS and filtered across PSSCH transmission occasions using filter configuration provided by sl-FilterCoefficient.
UE-B reports the “higher layer filtered RSRP” to UE-A, wherein the reporting can be PC5-RRC signaling and/or PC-5 MAC CE signaling and/or L1 control signaling (e.g., SCI signaling, for example second stage SCI and/or first state SCI).
UE-A calculates the SL path-loss using the obtained referenceSignalPower and reported “higher layer filtered RSRP” (e.g., SL PL=referenceSignalPower—“higher layer filtered RSRP”).

In a second example, UE-A transmits PSSCH1/PSCCH1, and UE-B receives PSSCH1/PSCCH1, and UE-B transmits PSSCH2/PSCCH2, and UE-A receives PSSCH2/PSCCH2. UE-A estimates the SL PL as follows.
UE-B obtains reference SignalPower by summing the PSSCH2 transmit power per RE over antenna ports and higher layer filtered across PSSCH2 transmission occasions using filter configuration provided by sl-FilterCoefficient.
UE-B reports the referenceSignalPower to UE-A, wherein the reporting can be PC5-RRC signaling and/or PC-5 MAC CE signaling and/or L1 control signaling (e.g., SCI signaling, for example second stage SCI and/or first state SCI).
UE-A measures the “higher layer filtered RSRP” by measuring the SL RSRP on PSSCH2DMRS and filtered across PSSCH2 transmission occasions using filter configuration provided by sl-FilterCoefficient.
UE-A calculates the SL path-loss using the reported reference SignalPower and obtained “higher layer filtered RSRP” (e.g., SL PL=referenceSignalPower—“higher layer filtered RSRP”).

In a third example, UE-A calculates a first SL PL according to the first example and a second SL PL according to the second example and averages the first and second SL PL values using a filter configuration provided by sl-PLFilter which can be provided per-carrier and applied when UE-A transmissions of PSSCH1/PSCCH1 to UE-B and UE-B transmissions of PSSCH2/PSCCH2 to UE-A are on a same carrier, or using a filter configuration provided by sl-PLFilter-ca which can be provided per-carrier pair and applied when UE-A transmissions of PSSCH1/PSCCH1 to UE-B and UE-B transmissions of PSSCH2/PSCCH2 to UE-A are on different carriers.

In a fourth example, UE-A calculates a SL PL based on an RS resource q_{d} transmitted by UE-A for determining the pathloss for carrier f, which is given by PL_{SL,e} (q_{d})=Reference SignalPower—“higher layer filtered RSRP”, where
referenceSignalPower is obtained summing the RS resource q_{d} transmit power over antenna ports and higher layer filtered across RS transmission occasions using filter configuration provided by sl-FilterCoefficient, and
“higher layer filtered RSRP” is the SL RSRP measured by UE-B receiving the RS resource q_{d} and reported to UE-A that transmitted the RS resource q_{d} for carrier f. The RS resource q_{d} for determining the SL PL for carrier f, can be the RS resource used for determining the power of a PSSCH transmission from UE-A or can be the RS resource corresponding to a SS/PBCH block.

In a fifth example, UE-A calculates a SL PL based on an RS resource q_{d} transmitted by UE-B for determining the pathloss for carrier f, which is given by PL_{SL,e} (q_{d})=reference SignalPower—“higher layer filtered RSRP”, where
referenceSignalPower is provided by higher layers, and
“higher layer filtered RSRP” is the SL RSRP measured by UE-A receiving the RS resource q_{d} for carrier f. The RS resource q_{d} for determining the SL PL for carrier f, can be the RS resource used for determining the power of a PSSCH transmission from UE-A or can be the RS resource corresponding to a SS/PBCH block.

In a sixth example, UE-A calculates a first SL PL according to the fourth example and a second SL PL according to the fifth example, and averages the first and second SL PL values using a filter configuration provided by sl-PLFilter which can be provided per-carrier and applied when UE-A transmissions to UE-B and UE-B transmissions to UE-A are on a same carrier, or using a filter configuration provided by sl-PLFilter-ca which can be provided per-carrier pair and applied when UE-A transmissions to UE-B and UE-B transmissions to UE-A are on different carriers.

For each SL carrier f, a UE determines a power P_{PSSCH,f}(i) for a PSSCH transmission on a resource pool in symbols where a corresponding PSCCH is not transmitted in PSCCH-PSSCH transmission occasion i on active SL BWP b of carrier e as:

P_{PSSCH,f}(i)-min (P_{CMAX,f}) P_{MAX,CBR,e}, min (P_{PSSCH,D,e} (i), P_{PSSCH,SL,e} (i))) [dBm] where P_{CMAX,e} is the UE configured maximum output power for carrier fin PSSCH transmission occasion i; P_{MAX,CBR,e} is determined by a value of sl-MaxTxPower based on a priority level of the PSSCH transmission and a CBR range that includes a CBR measured in slot i-N, or if sl-MaxTxPower is not provided, P_{MAX,CBR,e}=P_{CMAX,e}; P_{PSSCH,D,e}(i)=P_{O,D,e}+10 log₁₀ (2^{μ}·M_{RB,f}^{PSSCH}(i)+α_{D,e}·PL_{D,e} is the transmit power derived from the DL-based pathloss for carrier f which is the same carrier over which PSSCH is transmitted; and P_{PSSCH,SL,e}(i)=P_{O,SL,e}+10 log₁₀ (^{μ}·M_{RB,f}^{PSSCH}(i))+α_{SL,e}·PL_{SL,e} is the transmit power derived from the SL-based pathloss for carrier f.

For the transmit power of PSSCH derived from the DL-based power control P_{PSSCH,D,e}(i), parameters P_{O,D,e} and α_{D,e} are provided by higher layer and associated with the carrier f, and M_{RB,f}^{PSSCH} is a number of resource blocks for the PSSCH transmission occasion i and μ is a SCS configuration on carrier f.

P_{O,SL,e} is a value of a parameter dl-P0-PSSCH-PSCCH that may include separate values for each configured carrier, or separate values for a set of configured carriers including one or more carriers, or a single value for configured carriers. For the same carrier f, the value of P_{O,SL,e} can be different when the UE is configured with single carrier or with multiple carriers, or the value provided by the single carrier configuration can be the default value when the configuration for multiple carriers does not include the value for carrier f.

In one example, the UE can be configured with dl-P0-PSSCH-PSCCH that includes a single P0 value for the corresponding configured carrier f and/or with dl-P0-PSSCH-PSCCH-ca that includes multiple P0 values for the corresponding multiple configured carriers. Depending on whether the UE is configured with single or multiple carriers, for the carrier f the UE uses the corresponding P0 value provided by dl-P0-PSSCH-PSCCH or by the corresponding field in dl-P0-PSSCH-PSCCH-ca.
In a first sub-example, when dl-P0-PSSCH-PSCCH-ca is not configured, DL pathloss based power control is disabled for PSCCH/PSSCH.
In a second sub-example, when dl-P0-PSSCH-PSCCH-ca is configured, and the field value P0 corresponding to a first carrier of the multiple carriers is absent, DL pathloss based power control is disabled for PSCCH/PSSCH for the first carrier.
In a third sub-example, when dl-P0-PSSCH-PSCCH-ca is configured, and the field value P0 corresponding to a first carrier of the multiple carriers is absent in dl-P0-PSSCH-PSCCH-ca, the field value provided by dl-P0-PSSCH-PSCCH for single carrier operation is used for the DL pathloss based power control for the first carrier in multiple carrier operation.

In another example, the UE can be configured with dl-P0-PSSCH-PSCCH that includes a single P0 value for the corresponding configured carrier f, and/or with dl-P0-PSSCH-PSCCH-ca-FRx-1 that includes multiple PO values for corresponding carriers in a first set of carriers and with dl-P0-PSSCH-PSCCH-ca-FRx-2 that includes multiple P0 values for corresponding carriers in a second set of carriers. When dl-P0-PSSCH-PSCCH-ca-FRx-1 is not configured, DL pathloss based power control is disabled for PSCCH/PSSCH on the first set of carriers, and when dl-P0-PSSCH-PSCCH-ca-FRx-2 is not configured, DL pathloss based power control is disabled for PSCCH/PSSCH on the second set of carriers. Parameters dl-P0-PSSCH-PSCCH-ca-FRx-1 and dl-P0-PSSCH-PSCCH-ca-FRx-2 can be associated with carriers in FR1 (x=1) or in FR2 (x=2).

α_{D,e} is the alpha value provided by dl-Alpha-PSSCH-PSCCH that indicates alpha value for DL pathloss based power control for PSCCH/PSSCH when dl-P0-PSSCH-PSCCH is configured. When the field is absent the UE applies the value 1. The dl-Alpha-PSSCH-PSCCH may include separate values for each configured carrier, or separate values for a set of configured carriers including one or more carriers, or a single value for configured carriers. For the same carrier f, the value of ape can be different when the UE is configured with single carrier or with multiple carriers, or the value provided by the single carrier configuration can be the default value when the configuration for multiple carriers does not include the value for carrier f.

In one example, the UE can be configured with dl-Alpha-PSSCH-PSCCH that includes a single α_{D} value for the corresponding configured carrier f and/or with dl-Alpha-PSSCH-PSCCH-ca that includes multiple α_{D} values for the corresponding multiple configured carriers. Depending on whether the UE is configured with single or multiple carriers, for the carrier f the UE uses the corresponding α_{D} value provided by dl-Alpha-PSSCH-PSCCH or by the corresponding field in dl-Alpha-PSSCH-PSCCH-ca.
In a first sub-example, when dl-P0-PSSCH-PSCCH-ca is not configured, DL pathloss based power control is disabled for PSCCH/PSSCH.
In a second sub-example, when dl-P0-PSSCH-PSCCH-ca is configured, and the field value α_{d} in dl-Alpha-PSSCH-PSCCH-ca corresponding to a first carrier of the multiple carriers is absent, the UE applies the value 1.
In a third sub-example, when dl-P0-PSSCH-PSCCH-ca is configured and the field value α_{D} corresponding to a first carrier of the multiple carriers is absent in dl-Alpha-PSSCH-PSCCH-ca, the field value provided by dl-Alpha-PSSCH-PSCCH for single carrier operation is used for the DL pathloss based power control for the first carrier in multiple carrier operation.

In another example, the UE can be configured with dl-Alpha-PSSCH-PSCCH that includes a single α_{D} value for the corresponding configured carrier f, and/or with dl-Alpha-PSSCH-PSCCH-ca-FRx-1 that includes multiple α_{D} values for corresponding carriers in a first set of carriers and with dl-Alpha-PSSCH-PSCCH-ca-FRx-2 that includes multiple α_{D} values for corresponding carriers in a second set of carriers. Parameters dl-Alpha-PSSCH-PSCCH-ca-FRx-1and dl-Alpha-PSSCH-PSCCH-ca-FRx-2 can be associated with carriers in FR1 (x=1) or in FR2(x=2).

For the transmit power of PSSCH derived from the SL-based power control P_{PSSCH,SL,e} (i), parameters P_{O,SL,e}, and α_{SL,e} are provided by higher layer and associated with the carrier f.

P_{O,SL,e} is a value of a parameter sl-P0-PSSCH-PSCCH that may include separate values for each configured carrier, or separate values for a set of configured carriers including one or more carriers, or a single value for configured carriers. For the same carrier f, the value of P_{O,SL,e} can be different when the UE is configured with single carrier or with multiple carriers, or the value provided by the single carrier configuration can be the default value when the configuration for multiple carriers does not include the value for carrier f.

In one example, the UE can be configured with sl-P0-PSSCH-PSCCH that includes a single P0 value for the corresponding configured carrier f and/or with sl-P0-PSSCH-PSCCH-ca that includes multiple P0 values for the corresponding multiple configured carriers. Depending on whether the UE is configured with single or multiple carriers, for the carrier f the UE uses the corresponding P0 value provided by sl-P0-PSSCH-PSCCH or by the corresponding field in sl-P0-PSSCH-PSCCH-ca.

In a first sub-example, when sl-P0-PSSCH-PSCCH-ca is not configured, SL pathloss based power control is disabled for PSCCH/PSSCH.
In a second sub-example, when sl-P0-PSSCH-PSCCH-ca is configured, and the field value P0 corresponding to a first carrier of the multiple carriers is absent, SL pathloss based power control is disabled for PSCCH/PSSCH for the first carrier.
In a third sub-example, when sl-P0-PSSCH-PSCCH-ca is configured, and the field value P0 corresponding to a first carrier of the multiple carriers is absent in sl-P0-PSSCH-PSCCH-ca, the field value provided by sl-P0-PSSCH-PSCCH for single carrier operation is used for the SL pathloss based power control for the first carrier in multiple carrier operation.

In another example, the UE can be configured with sl-P0-PSSCH-PSCCH that includes a single P0 value for the corresponding configured carrier f, and/or with sl-P0-PSSCH-PSCCH-ca-FRx-1 that includes multiple P values for corresponding carriers in a first set of carriers and with sl-P0-PSSCH-PSCCH-ca-FRx-2 that includes multiple P0 values for corresponding carriers in a second set of carriers. When sl-P0-PSSCH-PSCCH-ca-FRx-1 is not configured, SL pathloss based power control is disabled for PSCCH/PSSCH on the first set of carriers. When sl-P0-PSSCH-PSCCH-ca-FRx-2 is not configured, SL pathloss based power control is disabled for PSCCH/PSSCH on the second set of carriers. Parameters sl-P0-PSSCH-PSCCH-ca-FRx-1 and sl-P0-PSSCH-PSCCH-ca-FRx-2 can be associated with carriers in FR1 (x=1) or in FR2 (x=2).

α_{SL,e} is the alpha value provided by sl-Alpha-PSSCH-PSCCH that indicates alpha value for SL pathloss based power control for PSCCH/PSSCH when sl-P0-PSSCH-PSCCH is configured. When the field is absent the UE applies the value 1. The sl-Alpha-PSSCH-PSCCH may include separate values for each configured carrier, or separate values for a set of configured carriers including one or more carriers, or a single value for configured carriers. For the same carrier f, the value of α_{SL,e} can be different when the UE is configured with single carrier or with multiple carriers, or the value provided by the single carrier configuration can be the default value when the configuration for multiple carriers does not include the value for carrier f.

In one example, the UE can be configured with sl-Alpha-PSSCH-PSCCH that includes a single α_{SL} value for the corresponding configured carrier f and/or with sl-Alpha-PSSCH-PSCCH-ca that includes multiple α_{SL} values for the corresponding multiple configured carriers. Depending on whether the UE is configured with single or multiple carriers, for the carrier f the UE uses the corresponding α_{SL} value provided by sl-Alpha-PSSCH-PSCCH or by the corresponding field in sl-Alpha-PSSCH-PSCCH-ca.
In a first sub-example, when sl-P0-PSSCH-PSCCH-ca is not configured, SL pathloss based power control is disabled for PSCCH/PSSCH.
In a second sub-example, when sl-P0-PSSCH-PSCCH-ca is configured, and the field value α_{SL} in sl-Alpha-PSSCH-PSCCH-ca corresponding to a first carrier of the multiple carriers is absent, the UE applies the value 1.
In a third sub-example, when sl-P0-PSSCH-PSCCH-ca is configured, and the field value α_{SL} corresponding to a first carrier of the multiple carriers is absent in sl-Alpha-PSSCH-PSCCH-ca, the field value provided by sl-Alpha-PSSCH-PSCCH for single carrier operation is used for the SL pathloss based power control for the first carrier in multiple carrier operation.

In another example, the UE can be configured with sl-Alpha-PSSCH-PSCCH that includes a single α_{SL} value for the corresponding configured carrier f, and/or with sl-Alpha-PSSCH-PSCCH-ca-FRx-1 that includes multiple α_{SL} values for corresponding carriers in a first set of carriers and with sl-Alpha-PSSCH-PSCCH-ca-FRx-2 that includes multiple α_{SL} values for corresponding carriers in a second set of carriers. Parameters sl-Alpha-PSSCH-PSCCH-ca-FRx-1and sl-Alpha-PSSCH-PSCCH-ca-FRx-2 can be associated with carriers in FR1 (x=1) or in FR2(x=2).

FIG. 6 illustrates a diagram of an example CA configuration 600 according to embodiments of the present disclosure. For example, CA configuration 600 may be implemented within wireless network 100 of FIG. 1. This example is for illustration only and other embodiments can be used without departing from the scope of the present disclosure.

When UE-A (e.g., UE 111) and UE-B (e.g., UE 111B) are configured to operate with N carriers, on each carrier f of the N carriers UE-A (SL transmitting UE) transmits (e.g., PSCCH/PSSCH) to UE-B (SL receiving UE) and receives (e.g., RS, PSFCH) from UE-B. UE-A can be configured with DL-based power control and SL-based power control in a carrier of the N carriers, receive in the carrier a reference signal from the gNB to estimate a DL pathloss, and/or transmit a SL reference signals to UE-B that estimates a SL RSRP from the SL reference signals reported to UE-A. With reference to FIG. 6, an example when UE-A (610) and UE-B (620) are configured with carrier aggregation with 2 carriers, f0 and f1 is shown. The gNB (630) transmits reference signals RS0 and RS1 on carrier f0 and f1 (640), respectively, and UE-A and UE-B transmissions/receptions use carriers f0 and f1 (650). UE-A transmits (e.g., PSCCH/PSSCH) in a carrier to UE-B and receives (e.g., PSFCH) from UE-B in the same carrier.

In one example, a UE is configured with DL-based power control and SL-based power control on each of the N carriers. The UE estimates DL PL values and SL PL values using corresponding configured reference resources on the N carriers.

The DL PL is given by PL_{D,f}=PL_{b,f,c} (q_{d}) when the active SL BWP is on carrier f of serving cell c, and q_{d} is the RS resource for determining the pathloss. The RS resource q_{d} for determining the DL pathloss is given by the RS (e.g., PL-RS) transmitted by gNB on carrier f and received and measured by the UE using a beam (spatial domain receive filter).

The SL PL is given by PL_{SL,f} when the active SL BWP is on carrier f of serving cell c, and can be determined by measuring the SL RSRP on PSSCH DMRS or on an RS resource q_{d}, transmitted from a transmitting SL UE or from a receiving SL UE.

In a first sub-example, the UE determines, for each carrier, a DL component of the PSSCH transmit power derived from the DL PL and on a SL component of the PSSCH transmit power derived from the SL PL, and calculates the transmit power as P_{PSSCH,f}(i)=min (P_{CMAX,f}, P_{MAX,CBR,f}, min (P_{PSSCH,D,f}(i), P_{PSSCH,SL,f}(i))).

In a second sub-example, the UE determines DL and SL pathloss values for carrier f as PL_{D,f} and PL_{SL,f}, and determines the transmit power for carrier f based on the smallest P_{Lf} value or the smallest α_{f}·PL_{f}:
If PL_{SL,f}<PL_{D,f}(or α_{SL,f}·PL_{SL,f}<α_{d,f}·PL_{D,f}), the UE determines the transmit power as P_{PSSCH,f}(i)=min (P_{CMAX,1}, P_{MAX,CBR,1}, P_{PSSCH,SL,f}(i)).
If PL_{SL,f}>PL_{D,f}(or α_{SL,f}·PL_{SL,f}>α_{d,f}·PL_{D,f}), the UE determines the transmit power as P_{PSSCH,f}(i)=min (P_{CMAX,1}, P_{MAX,CBR,1}, P_{PSSCH,DL,f}(i)).

In a third sub-example, the UE determines transmit powers for carriers based on the SL-based power control or based on the DL-based power control. This can be subject to satisfying a condition associated with the pathloss PL_{f} or with α_{f}·PL_{f} or with P_{O,f}, as in the following examples.
If the minimum PL_{f}, or the minimum α_{f}·PL_{f}, or the minimum P_{O,f} among carriers is associated with the SL PL then the UE determines transmit powers for carriers using the SL-based power control P_{PSSCH,f}(i)=min (P_{CMAX,f}, P_{MAX,CBR,f}, P_{PSSCH,SL,f}(i))
If the minimum PL_{f}, or the minimum α_{f}·PL_{f}, or the minimum P_{O,f} among carriers is associated with the DL PL then the UE determines the transmit powers on carriers from the DL-based power control P_{PSSCH,f}(i)=min (P_{CMAX,e}, P_{MAX,CBR,e}, P_{PSSCH,D,e}(i)).
If SL pathloss values of the N carriers are below a configured threshold, the UE determines the transmit powers on each of the carriers using a corresponding SL-based power control.

In a fourth sub-example, the UE determines transmit powers for carriers using the SL-based power control or the DL-based power control subject to a configuration that indicates to use the same interface (Uu or PC5) for determining the pathloss and the associated transmit power on carriers. Whether to use DL or SL interface can be subject to conditions on the pathloss values (as in the third sub-example), or can be indicated by higher layer signaling (e.g., RRC signaling) or MAC CE signaling, or L control (e.g., DCI or SCI) signaling. For example, a MAC CE can indicate that for configured carriers (or for a set of the configured carriers including more than one carrier) the UE uses DL-based or SL-based transmit power control. A bitmap of N bits corresponding to the N carriers can indicate the carriers over which the transmit power control shall be based on DL PL and SL PL (or on DL PL only) if the value is ‘0’ and indicate the carriers over which the transmit power control shall be based on SL PL only if the value is ‘1’, or vice versa. For example, a L1 control signaling can be a 1-bit signaling on each carrier that indicates that the transmit power control shall be based on DL PL only if the value is ‘0’ or on SL PL only if the value is ‘1’, or vice versa.

Without a loss of generality, some of the following examples are described for two carriers, carrier 1 and carrier 2, or f1 and f2, but they are applicable to any number N of carriers, wherein the N carriers may include one or more carriers for which both DL and SL power control based on pathloss is configured, or one or more carriers for which only SL power control based on pathloss is configured, or one or more carriers for which only DL power control based on pathloss is configured.

In one example, UE-A is configured with DL and SL power control on carrier 1 and with SL power control on carrier 2. For carrier 1, UE-A estimates the DL pathloss and the SL pathloss using corresponding configured reference resources received from the gNB (e.g., gNB 102) and UE-B, respectively, and determines a transmit power for PSSCH/PSCCH as the minimum among the DL-based and the SL-based power components. For carrier 2, the UE estimates the SL pathloss using corresponding configured reference resources received from UE-B and determines a corresponding transmit power for PSSCH/PSCCH. Since SL-based only power control is configured in at least one carrier of the multiple carriers configured or used to transmit/receive to/from UE-B, UE-A uses SL-based power control on both carriers. Alternatively, or additionally to the configured power control on each carrier, UE-A and UE-B receive an indication from the gNB to use the SL-based only transmit power control on carriers configured or used to transmit/receive to/from UE-A and UE-B, by higher layer signaling (e.g., RRC signaling) or MAC CE signaling, or L1 control (e.g., DCI or SCI) signaling. The indication to use SL-based only transmit power control is transmitted by the gNB only on carrier 1 which is the carrier over which both DL-based power control and SL-based power control are enabled and/or were previously configured.

In one example, UE-A is configured with DL and SL power control on carrier 1 and with DL power control on carrier 2. For carrier 1, the UE estimates the DL pathloss and the SL pathloss using corresponding configured reference resources received from the gNB and UE-B, respectively, and determines a transmit power for PSSCH/PSCCH as the minimum among the DL-based and the SL-based component. For carrier 2, the UE estimates the DL pathloss using corresponding configured reference resources received from the gNB and determines a corresponding transmit power for PSSCH/PSCCH. Since DL-based only power control is configured in at least one carrier of the multiple carriers configured or used to transmit/receive to/from UE-B, UE-A uses DL-based only power control on both carriers. Alternatively, or additionally to the configured power control on each carrier, UE-A and UE-B receive an indication from the gNB to use the DL-based transmit power control on carriers configured or used to transmit/receive to/from UE-A and UE-B, by higher layer signaling (e.g., RRC signaling) or MAC CE signaling, or L1 control (e.g., DCI or SCI) signaling. The indication to use DL-based only transmit power control is transmitted by the gNB only on carrier 1 which is the carrier over which both DL-based power control and SL-based power control are enabled.

FIG. 7 illustrates a diagram of an example CA configuration 700 according to embodiments of the present disclosure. For example, CA configuration 700 may be implemented within wireless network 100 of FIG. 1. This example is for illustration only and other embodiments can be used without departing from the scope of the present disclosure.

When UE-A (e.g., UE 111) and UE-B (e.g., UE 111B) are configured to operate with N carriers, on each carrier f of the N carriers UE-A (SL transmitting UE) transmits (e.g., PSCCH/PSSCH) to UE-B (SL receiving UE) and receives (e.g., RS, PSFCH) from UE-B. UE-A can be configured with DL-based power control and SL-based power control in a carrier of the N carriers, receive in the carrier a reference signal from the gNB (e.g., gNB 102) to estimate a DL pathloss, transmit a SL reference signals to UE-B that estimates a SL RSRP from the SL reference signals reported to UE-A. UE-A transmits (e.g., PSCCH/PSSCH) in a carrier to UE-B and receives (e.g., PSFCH) from UE-B in a different carrier.

With reference to FIG. 7, an example when UE-A (710) and UE-B (720) are configured with carrier aggregation with 4 carriers, f0, f1, f2 and f3 is shown. The gNB (730) transmits reference signals RS0, RS1, RS2 and RS3 on carriers f0, f1, f2 and f3 (740), respectively, that are used by UE-A or UE-B to estimate a DL pathloss. UE-A and UE-B transmissions/receptions use carriers f0 and f1, f2 is used for UE-A transmissions to UE-B, and f4is used for UE-B transmissions to UE-A (750).

In one example UE-A transmits (e.g., PSCCH/PSSCH) in carrier f2 to UE-B and receives (e.g., PSFCH) from UE-B in carrier f3; in another example, UE-A transmits (e.g., PSCCH/PSSCH) in carrier f0 to UE-B and receives (e.g., PSFCH) from UE-B in carrier f0; in yet another example, UE-A transmits (e.g., PSCCH/PSSCH) in carrier f1 to UE-B and receives (e.g., PSFCH) from UE-B in carrier f1.

Other combinations of transmissions/receptions in different carriers are evaluated based on configurations. For the example of 4 carriers, UE-A can transmit to UE-B on f0, f1, f2carriers and receive from UE-B only on f3. UE-A can transmit/receive to/from UE-B on f0, f1, f2carriers but the PSFCH is only received by UE-A and transmitted by UE-B in f3.

In one example, UE-A and UE-B are configured to operate with 2 carriers. UE-A transmits (e.g., PSCCH/PSSCH) to UE-B in carrier f0 and receives (e.g., RS, PSFCH) from UE-B in carrier f1. UE-A estimates the DL PL and the SL PL, and then calculates the transmit power of PSSCH/PSCCH to UE-B for transmission in carrier f0. The gNB provides RS resources in carrier f0 (RS-0) and in carrier f1 (RS-1).

UE-A estimates the DL PL, which is given by PL_{D,f0}=PL_{b,f,c}(q_{d}) for carrier f0 on the active SL BWP on serving cell c. q_{d} is the RS resource for determining the pathloss transmitted by the gNB on carrier f0. PL_{b,f,c} (q)=referenceSignalPower—higher layer filtered RSRP, where reference SignalPower is provided by higher layers and RSRP is defined for the reference serving cell and the higher layer filter configuration provided by QuantityConfig defined for the reference serving cell.

UE-A estimates the SL PL as follows.
UE-A obtains reference SignalPower by summing the PSSCH transmit power per RE over antenna ports in carrier f0 and higher layer filtered across PSSCH transmission occasions using filter configuration provided by sl-FilterCoefficient.
UE-B measures the “higher layer filtered RSRP” by measuring the SL RSRP on PSSCH DMRS in carrier f0 and filtered across PSSCH transmission occasions using filter configuration provided by sl-FilterCoefficient.
UE-B reports the “higher layer filtered RSRP” to UE-A in carrier f1, wherein the reporting can be PC5-RRC signaling and/or PC-5 MAC CE signaling and/or L1 control signaling (e.g., SCI signaling, for example second stage SCI and/or first state SCI).
UE-A calculates the SL path-loss using the obtained referenceSignalPower and reported “higher layer filtered RSRP” (e.g., SL PL=referenceSignalPower—“higher layer filtered RSRP”).

When UE-B reports the “higher layer filtered RSRP” to UE-A in carrier f1 by L1control signaling (e.g., SCI signaling, for example second stage SCI and/or first state SCI), UE-B can estimate the power of the SCI that is transmitted in carrier f1 using the DL PL which is obtained from RSRP measurements of the RS resource received in carrier f1. Alternatively, or additionally, UE-B can estimate the SL PL on carrier f1.

FIG. 8 illustrates a diagram of an example CA configuration 800 for PSSCH and PSFCH transmission over different carriers. For example, CA configuration 800 for PSSCH and PSFCH transmission over different carriers may be implemented within wireless network 100 of FIG. 1. This example is for illustration only and other embodiments can be used without departing from the scope of the present disclosure.

With reference to FIG. 8, an example where a PSSCH and a PSFCH associated with the PSSCH are transmitted in different carriers is shown. UE-A (810) and UE-B (820) are configured with carrier aggregation with 4 carriers, f0, f1, f2 and f3. The gNB (830) transmits reference signals RS, RS1, RS2 and RS3 on carriers f0, f1, f2 and f3 (840), respectively, that are used by UE-A or UE-B to estimate a DL pathloss. UE-A transmissions of PSSCHs to UE-B use carriers f0, f1, f2 (850) and UE-B transmissions of PSFCHs associated with the PSSCHs use carrier f3 (860).

When UE-A (transmitting UE) and UE-B (receiving UE) are configured to operate with N carriers, in each carrier f of the N carriers UE-A (SL transmitting UE) transmits (e.g., PSCCH/PSSCH) to UE-B (SL receiving UE) and receives (e.g., RS, PSFCH) from UE-B.

In one example, UE-A (e.g., UE 111) transmits (e.g., PSCCH/PSSCH) in a carrier f to UE-B (e.g., UE 111B) and receives (e.g., PSFCH) from UE-B in the same carrier f. In another example, UE-A transmits (e.g., PSCCH/PSSCH) in a carrier f to UE-B and receives (e.g., PSFCH) from UE-B in a different carrier. In another example, for the transmission power of PSFCH, UE-B estimates a DL PL pathloss to determine the transmission power. Additionally, UE-A may provide its location information to UE-B (provided by the 2nd-stage SCI). If UE-B determines that the distance between UE-A and UE-B is too large, UE-B may not transmit the PSFCH. In another example, for carrier aggregation operation, the power of PSFCH in each of the carriers can be determined independently for each carrier as follows.

For the transmission power of PSFCH, for a carrier f of the N carriers, wherein the carrier f can be same or different carrier than the one used by UE-A to transmit the channel associated with the feedback information conveyed by the PSFCH (e.g., PSSCH), UE-B estimates a DL PL pathloss for carrier f to determine the transmission power. The DL PL is given by PL_{f}=PL_{b,f,c}(q_{d}) for carrier f on the active SL BWP on serving cell c. q_{d} is the RS resource for determining the pathloss transmitted by the gNB (e.g., gNB 102) in carrier f. UE-B determines the number of PSFCH transmissions, and first transmits PSFCHs with HARQ-ACK information in priority order (starting with the smallest priority value and in ascending order of priority value, i.e., from highest priority to lowest priority), until the maximum number of PSFCHs or the maximum PSFCH transmit power is reached in carrier f. If not reached, then the UE transmits PSFCHs with conflict information in priority order (starting with the smallest priority value and in ascending order of priority value, i.e., from highest priority to lowest priority) until the maximum number of PSFCHs or the maximum PSFCH transmit power is reached. If PSFCHs with other types of information is defined, those can be also transmitted according to their priority order. Thus, UE-B determines the DL PL for carrier f, a number N_{Tx,PSFCH} of simultaneous PSFCH transmissions for carrier f and a power P_{PSFCH,k}(i) for a PSFCH transmission k, 1≤k≤N_{Tx,PSFCH}, on a resource pool in PSFCH transmission occasion i on active SL BWP b of carrier f. The power of PSFCH is determined as P_{PSFCH,one}=P_{O,PSFCH}+10 log₁₀ (2^{μ})+α_{PSFCH}·PL [dBm], where P_{O,PSFCH} is a value that can be provided by a higher layer parameter (e.g., dl-P0-PSFCH-r17, dl-P0-PSFCH-r16, and α_{PSFCH} is a value of dl-Alpha-PSFCH, if provided, or α_{PFSCH}=1, and PL is a pathloss that depends on the carrier where the PSFCH is transmitted.

For sidelink with carrier aggregation, a total UE transmit power for transmissions over the multiple carriers is smaller than or equal to \hat{P}_{CMAX}(i) in every symbol of transmission occasion i. For simultaneous PSFCH transmissions in multiple carriers, if the total power for PSFCH transmissions over the multiple carriers in a respective transmission occasion i would exceed \hat{P}_{CMAX}(i), the UE allocates a power to PSFCH transmissions according to a priority order so that the total UE transmit power is smaller than or equal to \hat{P}_{CMAX}(i) in every symbol of transmission occasion i.

For sidelink with carrier aggregation, a determination of the power that the UE allocates to PSFCH transmissions can include a scaling of the power allocated to one or more of the PSFCH transmissions, and/or a selection of one or more PSFCHs that are not transmitted in transmission occasion i.

For sidelink with carrier aggregation, when UE-A (transmitting UE) and UE-B (receiving UE) are configured to operate with N carriers, UE-A transmits in corresponding carriers (e.g., PSCCH0, PSSCH1, . . . in carrier f0, f1, . . . ) to UE-B (SL receiving UE) and receives corresponding PSFCHs in one carrier from UE-B, wherein the one carrier can be one of the carriers where UE-A transmits PSSCHs or a different carrier from the one UE-A transmits PSSCHs.

With reference to FIG. 8, for the transmission power of PSFCHs in carrier f3associated with PSSCHs transmissions in carriers f0, f1, and f2, UE-B estimates a DL PL pathloss for carrier f3 using the RS resource transmitted by the gNB in carrier f3.

In one example, UE-B determines a number N_{Tx,PSFCH} of simultaneous PSFCH transmissions and a power P_{PSFCH,K}(i) for a PSFCH transmission k, 1≤k≤N_{Tx,PSFCH}, on a resource pool in PSFCH transmission occasion i on active SL BWP b of carrier f3, wherein the PSFCHs are associated with PSSCHs transmissions in carriers f0, f1 and f2. Thus, a PFSCH transmission occasion i can be associated with PSSCH transmissions on more than one carrier. The power of PSFCH is determined as P_{PSFCH,one}=P_{O,PSFCH}+10 log₁₀ (2^{μ})+α_{PSFCH}·PL [dBm], where P_{O,PSFCH} is a value that can be provided by a higher layer parameter (e.g., dl-P0-PSFCH-r17, dl-P0-PSFCH-r16) for carrier f3, and α_{PSFCH} is a value of dl-Alpha-PSFCH for carrier f3, if provided, or α_{PFSCH}=1, and PL is a pathloss for carrier f3.

In another example, UE-B determines a number N_{Tx,PSFCH} of simultaneous PSFCH transmissions and a power P_{PSFCH,k}(i) for a PSFCH transmission k, 1≤k≤N_{Tx,PSFCH}, on a resource pool in PSFCH transmission occasion i on active SL BWP b of carrier f3, wherein the PSFCHs are associated with PSSCHs transmissions in carrier f0, or in carrier f1 or in carrier f2. Thus, a PFSCH transmission occasion i can be associated with PSSCH transmissions on one carrier. The power of PSFCH is determined as P_{PSFCH,one}=P_{O,PSFCH}+10 log₁₀ (2^{μ})+α_{PSFCH}. PL [dBm], where P_{O,PSFCH} is a value that can be provided by a higher layer parameter (e.g., dl-P0-PSFCH-r17, dl-P0-PSFCH-r16) for carrier f3, and α_{PSFCH} is a value of dl-Alpha-PSFCH for carrier f3, if provided, or α_{PFSCH}=1, and PL is a pathloss for carrier f3.

For sidelink with carrier aggregation, when UE-A is configured with both DL and SL power control over multiple carriers that are used to transmit/receive to/from UE-B, for each carrier UE-A estimates a DL PL using RS resources from the gNB and a SL PL using RS resources transmitted by UE-A (or transmitted by UE-B). The DL PL is measured from RS resources sent by gNB and the SL PL is measured from RS resources sent by UE-A (or UE-B) for a carrier f.

In one example, UA-A transmits PSSCH/PSCCH transmission or PSFCH transmission to UE-B on a carrier and receives PSFCH reception or PSSCH/PSCCH reception from UE-B on the same carrier. For example, UE-A and UE-B are configured with SL CA over a number N of carriers, and the UE pair of UE-A and UE-B transmits and receives on the same carrier for each of the multiple carriers. UE-A determines the transmit power for PSSCH/PSCCH transmission or PSFCH transmission to UE-B based on the SL PL or on the DL PL. UE-A can use the DL PL to determine whether to send an indication to UE-B to increase the power of UE-B transmissions that are received by UE-A (e.g., transmit power control command indicates increase or decrease the power of a configured number of dBs). When applicable, the DL PL can also be used to determine the number of dBs to increase the UE-B transmissions requested by UE-A (e.g., transmit power control command indicates increase or decrease of 8 dB). When UE-A requests to UE-B to increase the transmit power of 8 dB, UE-A may also increase its transmit power of the same amount of 8dB or of a scaled amount that can be smaller or larger than 8 dB. UE-A uses the SL PL to determine the transmit power control command.

If the SL PL is larger than the DL PL of a certain dB range A, UE-A indicates to UE-B to increase the transmit power. The indication to increase the power is a SL transmit power control (TPC) command received by UE-B and can be a 1-bit field where the value ‘0’ indicates no change in transmit power and the value ‘1’ indicates to increase the transmit power of 8 dB, or the value ‘0’ indicates to increase the transmit power of 81 dB and value ‘1’ indicates to increase the transmit power of 82 dB, and 8 or 81 and 82, is/are pre-configured value(s) or configured in a SIB. The indication can be a 2-bit field where one value indicates no change in transmit power and the other three values indicate to increase the transmit power of 81 dB, 82 dB, 83 dB, respectively, and 81, 82, 83 are pre-configured values or configured in a SIB. The indication can be MAC CE signaling, or L1 control (e.g., DCI or SCI) signaling. The indication is not to transmit on that carrier. For example, UE-A indicates to UE-B not to transmit a PSFCH corresponding to a PSSCH transmitted by UE-A, or equivalently transmit with 0 power. The indication can be MAC CE signaling, or L1 control (e.g., DCI or SCI) signaling, and can be same or different signaling than the one that indicates to increase/decrease power of a number of dBs.

The procedure to increase the power based on a SL TPC command can be done independently in each carrier used for transmission/reception from/to UE-A and UE-B, or there can be limitations for up to a maximum number of carriers over which transmission of the TPC command by UE-A, or reception of the TPC command by UE-B, or application of the TPC command by UE-B.

For each carrier, a minimum time interval of one or more slots (e.g., m slot(s)) between consecutive TPC commands can be subject to a configuration. UE-A can transmit another TPC command after m slots from the slot used to transmit a most recent TPC command. UE-B does not expect to receive another TPC command until slot n+m when receives the TPC command in slot n. UE-B is expected to apply the power change not earlier than p slots after the slot where the corresponding TPC command was received.

For N carriers used to transmit/receive by UE-A and UE-B, in any given slot UE-A can be allowed to send the indication to increase the power in only one carrier or in up to a maximum number of carriers, N_c, that can be same or smaller than N. Upon reception of multiple indications in corresponding multiple carriers, UE-B can be allowed to increase the transmit power according to the indications in any given slot for PSFCH transmission and/or for PSSCH/PSCCH transmission that are received by UE-A, for a maximum number of carriers, N_p, wherein N_p can be the same or smaller than N_c.

In one example, UA-A transmits PSSCH/PSCCH transmission or PSFCH transmission to UE-B on a carrier and receives PSFCH reception or PSSCH/PSCCH reception from UE-B on a different carrier. For example, UE-A and UE-B are configured with SL CA over N of carriers, and N_A carriers of the N carriers are used for UE-A transmissions to UE-B and for UE-B receptions from UE-A, and N_B carriers of the N carriers are used for UE-B transmissions to UE-A and for UE-A receptions from UE-B. There are also carriers among the N carriers for which UE-A transmissions to UE-B and corresponding UE-A receptions from UE-B are on the same carrier.

UA-A transmits PSSCH/PSCCH transmission or PSFCH transmission to UE-B on a carrier f0 and receives PSFCH reception or PSSCH/PSCCH reception from UE-B on carrier f1.UE-A estimates a DL PL using RS resources from the gNB on carrier f1 and a SL PL using RS resources from UE-B on carrier f1. UE-A can use the DL PL to determine whether to send an indication to UE-B to increase the powers of UE-B transmissions that are received by UE-A. When applicable, the DL PL can also be used to determine the content of the indication that can be the number of dBs to increase the UE-B transmissions requested by UE-A. The transmit power of UE-A to UE-B on carrier f0 is not increased when UE-A requests to UE-B to increase the transmit power.

Similar to the previous example when UE-A transmissions to UE-B are on the same carriers where UE-A receptions from UE-B are received, when the SL PL on carrier f1 is larger than the DL PL on carrier c2 of a certain dB range Δ, UE-A indicates on carrier f0 to UE-B to increase the transmit power by MAC CE signaling, or L1 control (e.g., DCI or SCI) signaling. The procedure to increase the power based on a SL TPC command can be done independently in each carrier used for UE-A receptions from UE-B, or there can be limitations on the maximum number of carriers over which reception of TPC commands by UE-B is in a given slot, or on the maximum number of carriers over which application of TPC commands by UE-B. The indication can be not to transmit on that carrier. For example, UE-A indicates to UE-B not to transmit a PSFCH corresponding to a PSSCH transmitted by UE-A, or equivalently transmit with 0 power. The indication can be MAC CE signaling, or L1 control (e.g., DCI or SCI) signaling, and can be same or different signaling than the one that indicates to increase/decrease power of a number of dBs.

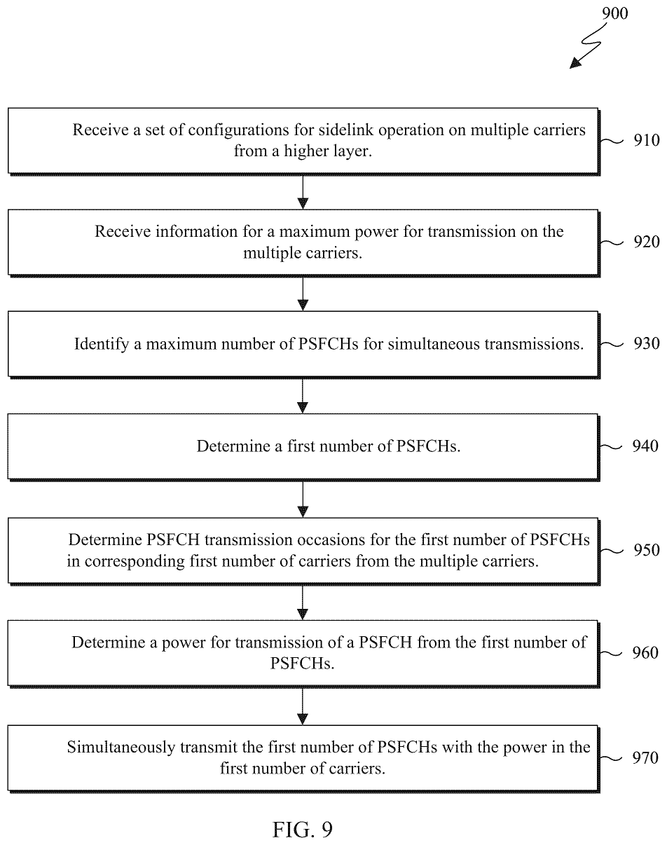

FIG. 9 illustrates an example method 900 performed by a UE in a wireless communication system according to embodiments of the present disclosure. The method 900 of FIG. 9 can be performed by any of the UEs 111-116 of FIG. 1, such as the UE 116 of FIG. 3, and a corresponding method can be performed by any of the BSs 101-103 of FIG. 1, such as BS 102 of FIG. 2, and/or another UE such as anyone of UEs 111-111C in FIG. 1. The method 900 is for illustration only and other embodiments can be used without departing from the scope of the present disclosure.

The method begins with the UE receiving a set of configurations for sidelink operation on multiple carriers from a higher layer (910). For example, in 910, a first carrier of the multiple carriers may be a DL carrier and a second carrier of the multiple carriers may be a sidelink carrier. The UE then receives information for a maximum power for transmission on the multiple carriers (920).

The UE then identifies a maximum number of PSFCHs for simultaneous transmissions (930). For example, in 930, the identification of the a maximum number of PSFCHs for simultaneous transmissions is based on a UE capability. The UE then determines a first number of PSFCHs (940). The UE then determines PSFCH transmission occasions for the first number of PSFCHs in corresponding first number of carriers from the multiple carriers (950). For example, in 950, the PSFCH transmission occasions for the first number of PSFCHs are determined based on the set of configurations. In various embodiments, the PSFCH transmission occasions in the multiple carriers are time-aligned.

The UE then determines a power for transmission of a PSFCH from the first number of PSFCHs (960). For example, in 960, the power is determined based on the set of configurations. In various embodiments, the first number of PSFCHs does not exceed the maximum number of PSFCHs and a total power for transmission of the first number of PSFCHs does not exceed the maximum power. In various embodiments, the transmission of the PSFCH that includes HARQ-ACK information in response to a reception of a PSSCH is in a first carrier and the reception of the PSSCH is in a second carrier.

In various embodiments, the UE may also receive first RS resources and second RS resources in a first carrier of a downlink and determine a path loss based on the first RS resources and the second RS resources and the power based on the path loss. In various embodiments, the UE may also receive, in a first carrier of the multiple carriers first RS resources in a downlink, and second RS resources in a sidelink and determine a first path loss based on the first RS resources, a second path loss based on the second RS resources, and the power based on the first and second path loss.

The UE then simultaneously transmits the first number of PSFCHs with the power in the first number of carriers. For example, the UE may transmit the first number of PSFCHs in the PSFCH transmission occasions (970).

In various embodiments, the UE may also receive an SCI format in a PSSCH or in a PSCCH including a TPC and the TPC in the sidelink is determined based on sidelink or downlink RS resources.

In various embodiments, the UE may also receive a number of PSSCHs in a number of carriers from the multiple carriers and transmit, in a second carrier, the PSFCH with HARQ-ACK information in response to the number of PSSCHs. In some examples, the second carrier is not a carrier from the number of carriers.

In various embodiments, the UE may also receive reference signals associated with PSSCHs in a number of carriers and determine the power of the PSFCH with HARQ-ACK information in response to the number of PSSCHs, in the second carrier, based on a path loss associated with the reference signal in the second carrier.

The above flowchart illustrates an example method that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Any of the above variation embodiments can be utilized independently or in combination with at least one other variation embodiment.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive:
a set of configurations for sidelink operation on multiple carriers from a higher layer, and
information for a maximum power for transmission on the multiple carriers; and
a processor operably coupled to the transceiver, the processor configured to:
identify, based on a UE capability, a maximum number of physical sidelink feedback channels (PSFCHs) for simultaneous transmissions, and
determine, based on the set of configurations:
a first number of PSFCHs,
a PSFCH transmission occasion for the first number of PSFCHs in corresponding first number of carriers from the multiple carriers, and
a power for transmission of a PSFCH from the first number of PSFCHs, wherein:
the first number of PSFCHs does not exceed the maximum number of PSFCHs, and
a total power for transmission of the first number of PSFCHs does not exceed the maximum power,
wherein the transceiver is further configured to simultaneously transmit, in the PSFCH transmission occasion, the first number of PSFCHs with the power in the first number of carriers.

2. The UE of claim 1, wherein:
the transmission of the PSFCH that includes hybrid automatic repeat request acknowledgement (HARQ-ACK) information in response to a reception of a physical sidelink shared channel (PSSCH) is in a first carrier, and
the reception of the PSSCH is in a second carrier.

3. The UE of claim 1, wherein PSFCH transmission occasions in the multiple carriers are time-aligned.

4. The UE of claim 1, wherein a first carrier of the multiple carriers is a downlink (DL) carrier and a second carrier of the multiple carriers is a sidelink carrier.

5. The UE of claim 1, wherein:
the transceiver is further configured to receive first reference signal (RS) resources and second RS resources in a first carrier of a downlink; and
the processor is further configured to determine:
a path loss based on the first RS resources and the second RS resources, and
the power based on the path loss.

6. The UE of claim 1, wherein:
the transceiver is further configured to receive, in a first carrier of the multiple carriers:
first reference signal (RS) resources in a downlink, and
second RS resources in a sidelink; and
the processor is further configured to determine:
a first path loss based on the first RS resources,
a second path loss based on the second RS resources, and
the power based on the first and second path loss.

7. The UE of claim 6, wherein the transceiver is further configured to:
transmit a power control command (TPC) in the sidelink based on the first and second RS resources.

8. The UE of claim 1, wherein the transceiver is further configured to:
receive a number of physical sidelink shared channels (PSSCHs) in a number of carriers from the multiple carriers, and
transmit, in a second carrier, the PSFCH with hybrid automatic repeat request acknowledgement (HARQ-ACK) information in response to the number of PSSCHs.

9. The UE of claim 8, wherein:
the second carrier is not a carrier from the number of carriers, and
the power is determined based on a path loss associated with a downlink reference signal.

10. The UE of claim 8, wherein:
the transceiver is further configured to receive a reference signal associated with the PSSCH in the second carrier, and
the power is determined based on a path loss associated with the reference signal.

11. A method of user equipment (UE) in a wireless communication system, the method of comprising:
receiving:
a set of configurations for sidelink operation on multiple carriers from a higher layer, and
information for a maximum power for transmission on the multiple carriers;
identifying, based on a UE capability a maximum number of physical sidelink feedback channels (PSFCHs) for simultaneous transmissions;
determining, based on the set of configurations:
a first number of PSFCHs,
a PSFCH transmission occasion for the first number of PSFCHs in corresponding first number of carriers from the multiple carriers, and
a power for transmission of a PSFCH from the first number of PSFCHs, wherein:
the first number of PSFCHs does not exceed the maximum number of PSFCHs, and
a total power for transmission of the first number of PSFCHs does not exceed the maximum power; and
simultaneously transmitting, in the PSFCH transmission occasion, the first number of PSFCHs with the power in the first number of carriers.

12. The method of claim 11, wherein:
the transmission of the PSFCH that includes hybrid automatic repeat request acknowledgement (HARQ-ACK) information in response to a reception of a physical sidelink shared channel (PSSCH) is in a first carrier, and
the reception of the PSSCH is in a second carrier.

13. The method of claim 11, wherein PSFCH transmission occasions in the multiple carriers are time-aligned.

14. The method of claim 11, wherein a first carrier of the multiple carriers is a downlink (DL) carrier and a second carrier of the multiple carriers is a sidelink carrier.

15. The method of claim 11, further comprising:
receiving first reference signal (RS) resources and second RS resources in a first carrier of a downlink; and
determining a path loss based on the first RS resources and the second RS resources,
wherein the power is determined based on the path loss.

16. The method of claim 11, further comprising:
receiving, in a first carrier of the multiple carriers:
first reference signal (RS) resources in a downlink, and
second RS resources in a sidelink; and
determining:
a first path loss based on the first RS resources,
a second path loss based on the second RS resources, and
wherein the power is determined based on the first and second path loss.

17. The method of claim 16, further comprising:
transmitting a power control command (TPC) in the sidelink based on the first and second RS resources.

18. The method of claim 11, further comprising:
receiving a number of physical sidelink shared channels (PSSCHs) in a number of carriers from the multiple carriers; and
transmitting, in a second carrier, the PSFCH with hybrid automatic repeat request acknowledgement (HARQ-ACK) information in response to the number of PSSCHs.

19. The method of claim 18, wherein:
the second carrier is not a carrier from the number of carriers, and
the power is determined based on a path loss associated with a downlink reference signal.

20. The method of claim 18, further comprising:
receiving a reference signal associated with the PSSCH in the second carrier,
wherein the power is determined based on a path loss associated with the reference signal.
